(19) United States
(12) Patent Application Publication
(10) Pub. No.: US 2021/0029752 A1
(43) Pub. Date: Jan. 28, 2021

(54) Handling of a Mapped Identity in a Wireless Communication Network

(71) Applicant: Telefonaktiebolaget LM Ericsson (publ), Stockhlom (SE)

(72) Inventors: Oscar Ohlsson, Stockholm (SE); Peter Hedman, Helsingborg (SE); Peter Ramle, Mölnlycke (SE); Paul Schliwa-Bertling, Ljungsbro (SE)

(21) Appl. No.: 16/468,337

(22) PCT Filed: May 2, 2019
(86) PCT No.: PCT/SE2019/050389

§ 371 Date: Jun. 11, 2019

Related U.S. Application Data
(60) Provisional application No. 62/688,366, filed on Jun. 21, 2018.

(51) Int. Cl. H04W 76/11; H04W 8/08; H04W 48/16; H04W 76/27

(52) U.S. Cl. CPC H04W 76/11; H04W 76/27; H04W 48/16; H04W 8/08

(57) ABSTRACT

A wireless device (10) is configured to map a first type of identity (ID1) usable in a first type of wireless communication network (20) to a second type of identity (ID2) usable in a second type of wireless communication network (30). The second type of identity (ID2) may be mappable from any one of multiple different possible types of identities usable in different respective types of wireless communication networks, including the first type of identity (ID1). The wireless device (10) is also configured to transmit to a base station (36) signaling (60) that includes the second type of identity (ID2) and that indicates a type of identity, from among the multiple different possible types of identities, from which the second type of identity (ID2) is mapped by indicating that the second type of identity (ID2) is mapped from the first type of identity (ID1).

### TECHNICAL FIELD

The present application generally relates to wireless communication networks and more particularly relates to the handling of a mapped identity in a wireless communication network.

### BACKGROUND

Interworking between 4G and 5G wireless communication networks enables a user equipment (UE) to move between the networks while maintaining seamless session continuity. Such interworking requires the networks to be able to exchange mobility management and session management contexts between them, so that the UE's context can be transferred from one network to the other upon UE mobility. Accordingly, when the UE moves from a 5G network to a 4G network, the UE needs to identify to the 4G network the location of its context in the 5G network. The 4G network will then be able to retrieve the UE's context from the 5G network and seamlessly transition the UE to the 5G network using that context.

In a 5G network, the Access and Mobility Function (AMF) is the network node that stores the UE's context. This means that a UE moving to a 4G network needs to identify a certain AMF in the 5G network as having the UE's context. With AMFs each assigned a globally unique AMF identifier (GUAMI), the UE needs to effectively provide the 4G network with the GUAMI that identifies the AMF storing the UE's context. But the GUAMI is an identity used by the 5G network, not the 4G network. Accordingly, rather than explicitly providing the 4G network with such a GUAMI, the UE maps the GUAMI to an identity used by the 4G network; namely, a globally unique Mobility Management Entity (MME) identity (GUMMED. The UE then provides this GUMMEI mapped from the GUAMI to the 4G network.

Challenges arise, though, in how to handle such a GUMMEI mapped from a GUAMI. To properly route signaling messages for retrieving the UE's context, the 4G network needs to unambiguously understand that a GUMMEI provided by the UE is mapped from a 5G identifier, e.g., as opposed to being a native GUMMEI allocated by the 4G network itself. Providing unambiguous clarity in this regard, however, threatens to burden networks with the task of coordinating identity allocation with one another and thereby complicating network planning.

### SUMMARY

Some embodiments herein introduce signalling to indicate a type of identity from which another identity is mapped. The signalling in a sense, then, indicates a type-specific mapping, as opposed to generically, agnostically, or ambiguously indicating that some sort of identity mapping was performed but not indicating the type of identity from which the mapping was performed. In fact, where the mapping may be performed from multiple different possible types of identities, e.g., 2G/3G identities and 5G identities, the signalling in some embodiments may indicate from which of the multiple different possible types of identities mapping was performed. The signalling thereby introduces clarity to the recipient of the signalling, which may then exploit the signalling for, e.g., efficiently retrieving a context of a wireless device. With the context retrieved, connection establishment may prove more efficient and quicker, thereby reducing latency, conserving radio resources by avoiding additional connection establishment signalling, and conserving wireless device power consumption and battery life by avoiding additional signalling.

The signalling in some embodiments is transmitted from a wireless device, e.g., as access stratum (AS) signalling such as may occur due to idle mode mobility. The wireless device may for instance move from a 5G network to 4G network, such as an EPS network. In this case, the signalling may indicate that an EPS identity, e.g., a GUMMEI or a GUTI, is mapped from a 5G identity, e.g., a GUAMI or GUTI. For instance, where the EPS identity is a GUMMEI or a GUTI which includes the GUMMEI, the signalling may include a GUMMEI type field, with at least one possible value indicating that the GUMMEI is mapped from a 5G-GUTI or GUAMI. In embodiments where the EPS identity is mappable from either a 5G identity or a 2G/3G identity, then, the signalling indicates from which of a 5G identity and a 2G/3G identity the EPS identity is mapped.

More particularly, embodiments herein include a method performed by a wireless device. The method comprises mapping a first type of identity usable in a first type of wireless communication network to a second type of identity usable in a second type of wireless communication network. In some embodiments, the second type of identity is mappable from any one of multiple different possible types of identities usable in different respective types of wireless communication networks. In this case, the multiple different possible types of identities include the first type of identity. Regardless, the method also comprises transmitting to a base station signaling that includes the second type of identity and that indicates the second type of identity is mapped from the first type of identity. In some embodiments, for example, the signaling indicates a type of identity, from among the multiple different possible types of identities, from which the second type of identity is mapped by indicating that the second type of identity is mapped from the first type of identity.

In some embodiments, the second type of identity is a second type of network node identity usable to identify a network node in the second type of wireless communication network.

In some embodiments, the second type of identity is a globally unique Mobility Management Entity, MME, identity, GUMMEI. In one or more of these embodiments, the signaling comprises a Radio Resource Control, RRC, connection setup complete message, wherein the RRC connection setup complete message includes a GUMMEI type field. In this case, a first possible value of the GUMMEI type field indicates that the second type of identity is mapped from a 5G identifier, and a second possible value of the GUMMEI type field indicates that the second type of identity is mapped from a 2G or 3G identifier. Accordingly, the GUMMEI type field included in the RRC connection setup complete message transmitted by the wireless device has the first possible value to indicate the second type of identity is mapped from a 5G identifier.

In some embodiments, the first type of identity is a 5G identity and the first type of wireless communication network is a 5G wireless communication network.

In some embodiments, the different respective types of wireless communication networks include: a 5G wireless communication network; and a 2G wireless communication network and/or a 3G wireless communication network.

In some embodiments, the first type of identity is either a globally unique Access and Mobility Function, AMF, identity, GUAMI, or a 5G globally unique temporary identity, 5G-GUTI.

In some embodiments, the first type of identity identifies a network node in the first type of wireless communication network that has a context for the wireless device and/or with which the wireless device is registered.

In some embodiments, the method further comprises performing a procedure associated with mobility of the wireless device from the first type of wireless communication network to the second type of wireless communication network. In this case, the signaling is transmitted from the wireless device as part of the procedure.

Embodiments also include a method performed by a base station. The method comprises receiving signaling from a wireless device. The signaling includes a second type of identity usable in a second type of wireless communication network. In some embodiments, the second type of identity is mappable from any one of multiple different possible types of identities usable in different respective types of networks. In this case, the multiple different possible types of identities include a first type of identity usable in a first type of wireless communication network. In any event, the signaling indicates the second type of identity is mapped from the first type of identity. In some embodiments, for example, the signaling indicates a type of identity, from among the multiple different possible types of identities, from which the second type of identity is mapped by indicating that the second type of identity is mapped from the first type of identity.

In some embodiments, the method further comprises selecting a network node to which to route the signaling, based on the second type of identity and indication that the second type of identity is mapped from the first type of identity; and routing the signaling according to said selecting.

In some embodiments, the method further comprises performing a procedure associated with mobility of the wireless device from the first type of wireless communication network to the second type of wireless communication network, wherein said signaling is received from the wireless device as part of the procedure.

In some embodiments, the second type of identity is a second type of network node identity usable to identify a network node in the second type of wireless communication network.

In some embodiments, the second type of identity is a globally unique Mobility Management Entity, MME, identity, GUMMEI. For example, in some embodiments, the signaling comprises a Radio Resource Control, RRC, connection setup complete message, and the RRC connection setup complete message includes a GUMMEI type field. A first possible value of the GUMMEI type field indicates the second type of identity is mapped from a 5G identifier, and a second possible value of the GUMMEI type field indicates the second type of identity is mapped from a 2G or 3G identifier. Accordingly, the GUMMEI type field included in the RRC connection setup complete message transmitted by the wireless device has the first possible value to indicate the second type of identity is mapped from a 5G identifier.

In some embodiments, the first type of identity is a 5G identity and the first type of wireless communication network is a 5G network.

In some embodiments, the different respective types of networks include: a 5G network; and a 2G network and/or a 3G network.

In some embodiments, the first type of identity is either a globally unique Access and Mobility Function, AMF, identity, GUAMI, or a 5G globally unique temporary identity, 5G-GUTI.

In some embodiments, the first type of identity identifies a network node in the first type of wireless communication network that has a context for the wireless device and/or with which the wireless device is registered.

In some embodiments, the method further comprises receiving other signaling from a network node in the second network indicating which identities of the second type allocated by the network node are mapped from respective identities of the first type.

Embodiments further includes a method performed by a base station. The method comprises receiving signaling indicating which identities of a second type usable in a second type of wireless communication network are mapped from respective identities of a first type usable in a first type of wireless communication network. In some embodiments, the second type of identity is mappable from any one of multiple different possible types of identities usable in different respective types of networks, wherein the multiple different possible types of identities include the first type of identity.

In some embodiments, the multiple different possible types of identities further include a third type of identity usable in a third type of wireless communication network. In this case, the method further comprises receiving signaling indicating which identities of the second type are mapped from respective identities of the third type.

In some embodiments, the third type of identity is a Serving GPRS Support Node, SGSN, identity usable in a 2G or 3G network.

In some embodiments, the second type of identity is a globally unique Mobility Management Entity, MME, identity, GUMMEI.

In some embodiments, the first type of identity is a 5G identity and the first type of wireless communication network is a 5G network.

Embodiments also include a method performed by a network node. The method comprises transmitting, to a base station, signaling indicating which identities of a second type usable in a second type of wireless communication network are mapped from respective identities of a first type usable in a first type of wireless communication network. In some embodiments, the second type of identity is mappable from any one of multiple different possible types of identities usable in different respective types of networks, wherein the multiple different possible types of identities include the first type of identity.

In some embodiments, the multiple different possible types of identities further include a third type of identity usable in a third type of wireless communication network. In this case, the method further comprises transmitting signaling indicating which identities of the second type are mapped from respective identities of the third type.

In some embodiments, the third type of identity is a Serving GPRS Support Node, SGSN, identity usable in a 2G or 3G network.

In some embodiments, the second type of identity is a globally unique Mobility Management Entity, MME, identity, GUMMEI.

In some embodiments, the first type of identity is a 5G identity and the first type of wireless communication network is a 5G network.

Embodiments further include corresponding apparatus, computer programs, and computer-readable storage mediums.

For example, embodiments include a wireless device configured, e.g., via communication circuitry and processing circuitry, to map a first type of identity usable in a first type of wireless communication network to a second type of identity usable in a second type of wireless communication network. In some embodiments, the second type of identity is mappable from any one of multiple different possible types of identities usable in different respective types of wireless communication networks. In this case, the multiple different possible types of identities include the first type of identity. Regardless, the wireless device may also be configured to transmit to a base station signaling that includes the second type of identity and that indicates the second type of identity is mapped from the first type of identity. In some embodiments, for example, the signaling indicates a type of identity, from among the multiple different possible types of identities, from which the second type of identity is mapped by indicating that the second type of identity is mapped from the first type of identity.

Embodiments further include a base station configured, e.g., via communication circuitry and processing circuitry, to receive signaling from a wireless device. The signaling includes a second type of identity usable in a second type of wireless communication network. In some embodiments, the second type of identity is mappable from any one of multiple different possible types of identities usable in different respective types of networks. In this case, the multiple different possible types of identities include a first type of identity usable in a first type of wireless communication network. In any event, the signaling indicates that the second type of identity is mapped from the first type of identity. In some embodiments, for example, the signaling indicates a type of identity, from among the multiple different possible types of identities, from which the second type of identity is mapped by indicating that the second type of identity is mapped from the first type of identity.

Embodiments also include a base station configured, e.g., via communication circuitry and processing circuitry, to receive signaling indicating which identities of a second type usable in a second type of wireless communication network are mapped from respective identities of a first type usable in a first type of wireless communication network. In some embodiments, the second type of identity is mappable from any one of multiple different possible types of identities usable in different respective types of networks, wherein the multiple different possible types of identities include the first type of identity.

Embodiments further include a network node configured, e.g., via communication circuitry and processing circuitry, to transmit, to a base station, signaling indicating which identities of a second type usable in a second type of wireless communication network are mapped from respective identities of a first type usable in a first type of wireless communication network. In some embodiments, the second type of identity is mappable from any one of multiple different possible types of identities usable in different respective types of networks, wherein the multiple different possible types of identities include the first type of identity.

### BRIEF DESCRIPTION OF THE DRAWING

FIG. 1 is a block diagram of a wireless device configured for interoperation between first and second wireless communication networks according to some embodiments.

FIG. 2 is a block diagram of identity mapping from a 5G-GUTI to an EPS-GUTI according to some embodiments.

FIG. 3 is a block diagram of ANS.1 encoding of an RRC connection setup complete message according to some embodiments.

FIG. 4 is a block diagram of an Evolved Packet System (EPS) and a 5G System (5GS) according to some embodiments.

FIG. 5 is a block diagram of signaling from a combined MME-AMF node to an eNB according to some embodiments.

FIG. 6 is a call flow diagram for idle mode mobility from a 5G network to an EPS network according to some embodiments.

FIG. 7 is a call flow diagram of a E-UTRAN attach procedure according to some embodiments.

FIG. 8 is a logic flow diagram of a method performed by a wireless device according to some embodiments.

FIG. 9 is a logic flow diagram of a method performed by a base station according to some embodiments.

FIG. 10 is a logic flow diagram of a method performed by a network node according to some embodiments.

FIG. 11 is a block diagram of a wireless device according to some embodiments.

FIG. 12 is a block diagram of a wireless device according to other embodiments.

FIG. 13 is a block diagram of a base station according to some embodiments.

FIG. 14 is a block diagram of a base station according to other embodiments.

FIG. 15 is a block diagram of a network node according to some embodiments.

FIG. 16 is a block diagram of a network node according to other embodiments.

FIG. 17 is a block diagram of a wireless communication network according to some embodiments.

FIG. 18 is a block diagram of a user equipment according to some embodiments.

FIG. 19 is a block diagram of a virtualization environment according to some embodiments.

FIG. 20 is a block diagram of a communication network with a host computer according to some embodiments.

FIG. 21 is a block diagram of a host computer according to some embodiments.

FIG. 22 is a flowchart illustrating a method implemented in a communication system, in accordance with one embodiment.

FIG. 23 is a flowchart illustrating a method implemented in a communication system, in accordance with one embodiment.

FIG. 24 is a flowchart illustrating a method implemented in a communication system, in accordance with one embodiment.

FIG. 25 is a flowchart illustrating a method implemented in a communication system, in accordance with one embodiment.

### DETAILED DESCRIPTION

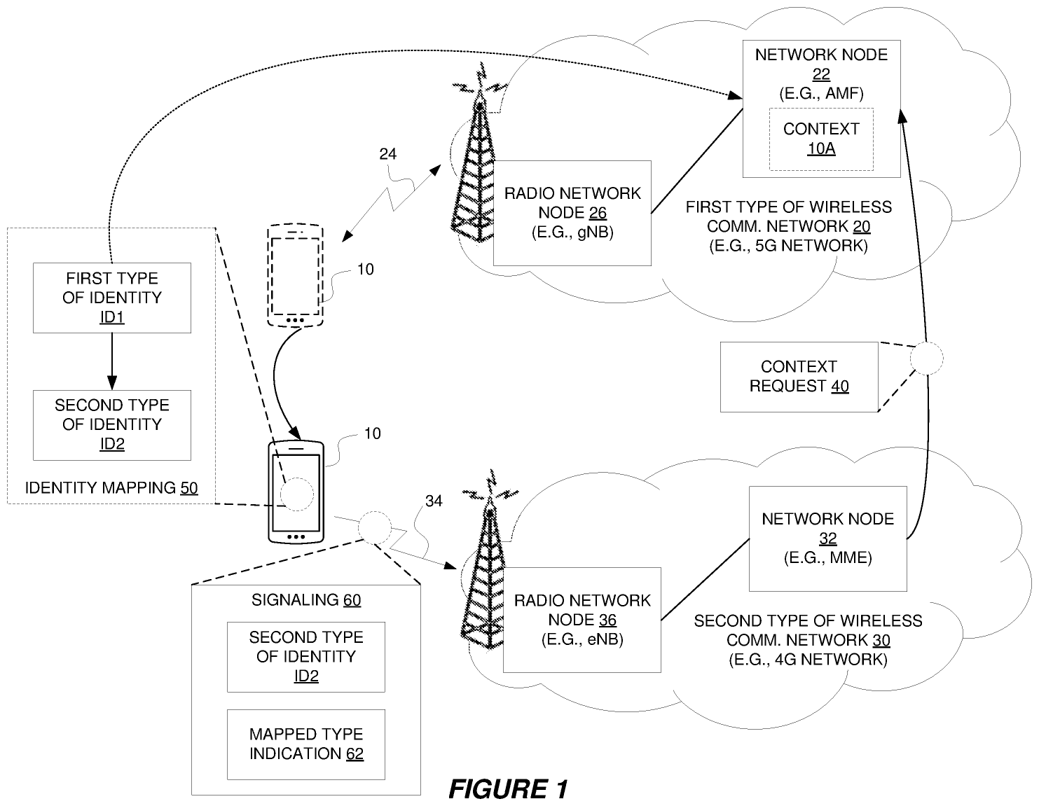

FIG. 1 shows a wireless device 10 according to some embodiments. The wireless device 10 is configured to operate in any one of multiple different types of wireless communication networks. As shown, for example, the wireless device 10 is configured to operate in a first type of wireless communication network 20, e.g., a 5G network such as a network based on the 5G System (5GS) or New Radio (NR) radio access network. The wireless device 10 is also configured to operate in a second type of wireless communication network 30, e.g., a 4G network such as a network based on the Evolved Packet System (EPS) or Evolved Terrestrial Radio Access Network (E-UTRAN). Configured in this way, the wireless device 10 may move between the different types of networks 20, 30 as needed, e.g., by performing a mobility procedure from one type of network to the other. The different types of networks 20, 30 are configured to inter-operate for seamless transition of the wireless device 10 between the networks 20, 30.

FIG. 1 in this regard shows that, when the wireless device 10 operates in the first type of wireless communication network 20, a network node 22 in that network 20 maintains a context 10A for the wireless device 10. The network node 22 may for instance implement an Access and Mobility Function (AMF) in a 5G network. The context 10A may contain information related to mobility management, session management, and/or security for the wireless device 10 in the first type of wireless communication network 20.

The wireless device 10 may nonetheless thereafter move to the second type of wireless communication network 30, e.g., while the wireless device 10 is in an idle mode such as an Radio Resource Control (RRC) idle mode. Mobility of the wireless device 10 in this sense means that the wireless device 10 moves from operating in or being served by the first network 20 to operating in or being served by the second network 30. Such mobility may occur with or without physical movement of the wireless device 10, e.g., responsive to channel conditions at the wireless device 10 changing. In some embodiments, for instance, this mobility from the first network 20 to the second network 30 is triggered when conditions of a first wireless channel 24 between the wireless device 10 and a radio network node 26 in the first network 20 become at least a certain extent worse than conditions of a second wireless channel 34 between the wireless device 10 and a radio network node 36 in the second network 30. In this and other cases, then, the wireless device 10 may switch from being served by the radio network node 26 in the first type of network 20 to being served by the radio network node 36 in the second type of network 30.

No matter the trigger or means for the mobility, the wireless device 10 is configured to effectively indicate, to the second type of network 30, that the network node 22 in the first type of network 20 has the wireless device's context 10A. This way, a network node 32 in the second type of network 30 can send a request 40 to the network node 22 in the first type of network 20 for retrieving the device's context 10A. This context 10A may be used to effect seamless transition of the wireless device 10 from the first type of network 20 to the second type of network 30.

More particularly in this regard, the network node 22 in the first type of network 20 is identified by a first type of identity ID1 usable in the first type of network 20. For example, where the network node 22 implements an AMF and the first type of network 20 is a 5G network, the first type of identity ID1 may be a globally unique AMF identifier (GUAMI). The wireless device 10 is configured to perform identity mapping 50 in order to map this first type of identity ID1 to a second type of identity ID2 usable in the second type of network 30. So mapped, the network node 22 in the first type of network 20 is identified by the second type of identity ID2 usable in the second type of network 30. For example, where the network node 32 is a Mobility Management Entity (MME) and the second type of network 30 is a 4G network, the second type of identity ID2 may be a globally unique MME identifier (GUMMED. In some embodiments, then, the wireless device 10 maps a GUAMI for the network node 22 to a GUMMEI. But rather than identifying an MME in the second type of network 30, the mapped GUMMEI identifies the AMF in the first type of network 20 that has the wireless device's context 10A.

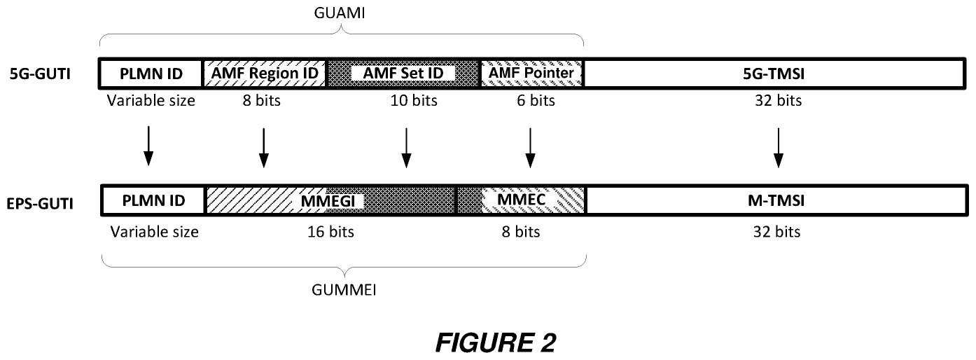

Note that the first type of identity ID1 may be part of a first type of encompassing identity and/or the second type of identity ID2 may be part of a second type of encompassing identity. In this case, the wireless device 10 may map the first type of identity ID1 to the second type of identity ID2 as part of mapping the first type of encompassing identity to the second type of encompassing identity. For example, the GUAMI is a part of a 5G globally unique temporary identity (5G-GUTI) that identifies the wireless device 10 in a 5G network and the GUMMEI is part of an EPS-GUTI that identifies the wireless device 10 in a 4G network. Accordingly, the wireless device 10 in some embodiments may map a GUAMI for the network node 22 to a GUMMEI as part of mapping the 5G-GUTI for the wireless device 10 to an EPS-GUTI for the wireless device 10. FIG. 2 shows one example of such a mapping. In FIG. 2, the public land mobile network (PLMN) identity (ID) of the 5G-GUTI maps to the PLMN ID of the EPS-GUTI. The AMF Region ID, the AMF Set ID, and the AMF pointer map to the MME Group ID (MMEGI) and the MME Code (MMEC) as shown according to the shading, e.g., such that one part of the AMF Set ID maps to a part of the MMEGI and the other part of the AMF Set ID maps to a part of the MMEC. Finally, the 5G Temporary Mobile Subscriber Identity (5G-TMSI) maps to the M-TMSI. In these and other embodiments, then, the GUAMI part of the 5G-GUTI maps to the GUMMEI part of the EPS-GUTI.

Irrespective of the particular form or nature of the identity mapping, though, the wireless device 10 in FIG. 1 transmits certain signaling 60 to a radio network node 36 in the second type of network 30. The signaling 60 may for instance be transmitted as part of a mobility procedure for mobility of the wireless device 10 from the first type of network 20 to the second type of network 30. In these or other embodiments, for instance, the signaling 60 may be access stratum (AS) signaling and/or include one or more Radio Resource Control (RRC) messages. In some embodiments, the signaling 60 may be transmitted while the wireless device 10 is in an idle mode such as an RRC idle mode. The signaling 60 may include one or more message, such as an attach request message, a tracking area update request message, an RRC connection setup complete message, and/or a message transmitted as part of a procedure to establish an RRC connection.

Regardless, the signaling 60 includes the second type of identity ID2, e.g., so as to identify that the network node 22 in the first type of network 20 has the wireless device's context 10A. Notably, the signaling 60 also indicates the second type of identity ID2 is mapped from the first type of identity ID1, e.g., via mapped type indication 62. That is, the signaling 60 indicates the first type of identity ID1 as being the type of identity from which the second type of identity ID2 is mapped. The signalling 60 in a sense, then, indicates a type-specific mapping, as opposed to generically, agnostically, or ambiguously indicating that some sort of identity mapping was performed but not indicating the type of identity from which the mapping was performed.

In fact, in some embodiments, the second type of identity ID2 is mappable from any one of multiple different possible types of identities usable in different respective types of wireless communication networks. For example, in some embodiments, another type of identity (not shown) usable in still another type of wireless communication network (not shown) can be mapped to the second type of identity ID2 as well. Where the second type of identity ID2 is a GUMMEI, for instance, it may also be possible to map a Serving GPRS Support Node (SGSN) identity usable in a 2G or 3G network to a GUMMEI. In this case, then, a GUMMEI is mappable either from an SGSN identity usable in a 2G/3G network or from a GUAMI usable in a 5G network. A GUMMEI may therefore effectively identify either an SGSN in a 2G/3G network or an AMF in a 5G network. This means that, when the second type of network 30 is provided with a mapped GUMMEI for identifying which network node has the device's context, there may be inherent ambiguity regarding whether an SGSN in a 2G/3G network has the device's context or an AMF in a 5G network has the device's context.

In these and other embodiments, the signalling 60 advantageously indicates from which one of the multiple different possible types of identities the second type of identity ID2 is mapped. In the example of FIG. 1, therefore, the signalling 60 indicates a type of identity, from among the multiple different possible types of identities, from which the second type of identity ID2 is mapped, by indicating the second type of identity ID2 is mapped from the first type of identity ID1. The signalling 60 may thereby introduce clarity to the recipient of the signalling, e.g., radio network node 36, regarding the identity of the network node 22 that has the device's context 10A. Where the second type of identity ID2 is a GUMMEI, for instance, the signalling 60 may indicate from which one of an SGSN identity or a GUAMI the GUMMEI is mapped.

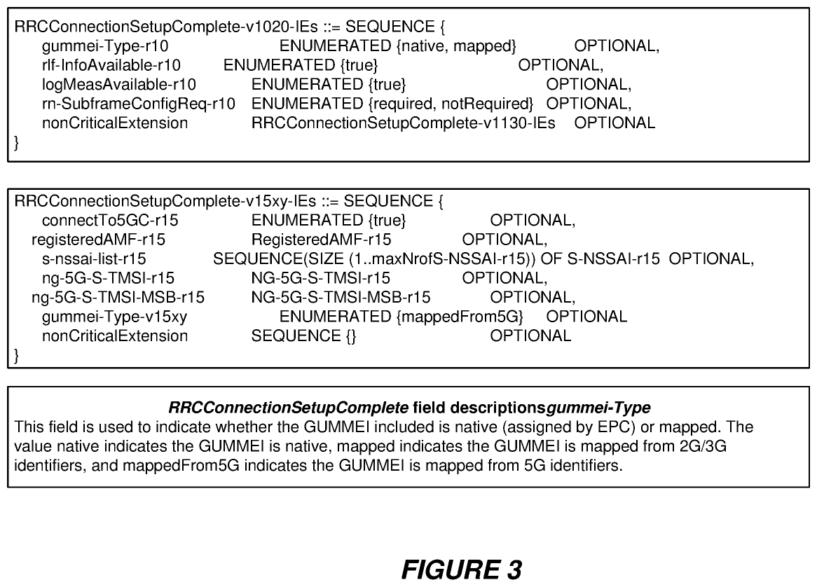

In some embodiments, for example, the signaling 60 includes a GUMMEI type field. One possible value for the GUMMEI type field, e.g., a value of “mapped”, indicates the GUMMEI is mapped from a 2G/3G identifier such as an SGSN identity. A different possible value for the GUMMEI type field, e.g., a value of “mappedFrom5G”, indicates the GUMMEI is mapped from a 5G identifier such as a GUAMI. FIG. 3 illustrates one example ASN.1 encoding for such embodiments where the signaling 60 is an RRC connection setup complete message transmitted from the wireless device 10 to the radio network node 36 to confirm the successful completion of an RRC connection establishment, e.g., for idle mode mobility to EPS. Revised

As shown in FIG. 3, the RRC connection setup complete messages has a gummei-Type field to indicate the type of the included GUMMEI. The gummei-Type field (with the “-r10” suffix) can be set to the value “native” to indicate that the included GUMMEI is native, i.e., assigned by the EPC itself. The gummei-Type field can also be set to the value “mapped”. If the “mapped” value just generically indicated the included GUMMEI is mapped, without more specifically indicating from which type of identifier the GUMMEI is mapped, ambiguity would exist regarding whether the GUMMEI is mapped from a 2G/3G identifier or from a 5G identifier. According to embodiments herein, then, this “mapped” value more specifically indicates the included GUMMEI is mapped from a 2G/3G identity; namely, an SGSN identifier such as a routing area identifier (RAI). And the gummei-Type field is extended by embodiments herein (using the field with the same name but with a “-v15xy” suffix) with a new value of “mappedFrom5G”. This “mappedFrom5G” value specifically indicates the included GUMMEI is mapped from a 5G identifier; namely, a GUAMI usable in a 5G network. The recipient of the signaling thereby is able to know whether the GUMMEI was mapped from 2G/3G or from 5G, without the 2G/3G mapped GUMMEIs and the 5G mapped GUMMEIs having to be coordinated to avoid collision.

In some embodiments, for ASN.1 Compatibility, a wireless device 10 that uses the extended gummei-Type field shall also set the gummei-Type to a value of “mapped”. In this way, a legacy eNB which is not able to parse the new extended field will treat the GUMMEI as being mapped from a 2G/3G identifier. It will then be up to the MME/network planner to ensure that there are no collisions between the GUMMEIs mapped from 5G and the GUMMEIs mapped from 2G/3G.

Note that while the first type of identity ID1 was described above for some embodiments as identifying a network node 22 in the first type of network 20 which has a context 10A for the wireless device 10, the first type of identity ID1 may alternatively or additionally identify a network node in the first type of network 20 with which the wireless device 10 is registered. In other embodiments, the first type of identity ID1 may identify the wireless device 10 itself in the first type of network 20, e.g., in the form of a 5G-GUTI. In this case, the second type of identity ID2 may be in the form of a type of identity that would identify the wireless device 10 itself in the second type of network 30. Generally, then, the first type of identity ID1 may be any type of identity usable in the first type of network 20.

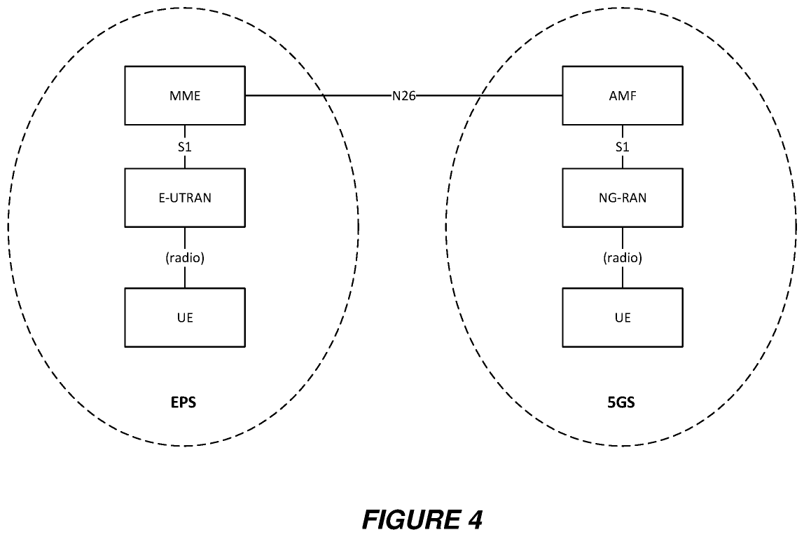

Consider now additional details of some embodiments specifically applicable for 5G to 4G mobility of the wireless device 10 in the form of a UE. The 3GPP TS 23.501 v15.2.0 describes the network architecture for the 5G System (5GS) (aka “5G”) and defines the procedures and interfaces for interworking with the legacy Evolved Packet System (EPS) (aka “4G”). A stripped down simplified version of 5GS and EPS interworking architecture is shown in FIG. 4. As shown, the EPS system includes an MME interconnected over the S1 interface with the E-UTRAN, which has a radio interface to the UE. The 5GS by contrast includes an AMF interconnected over the S1 interface with the NG-RAN, which has a radio interface to the UE. The MME and AMF are interconnected over the N26 interface.

When a UE in idle mode moves from 5GS to EPS, it needs to perform a Tracking Area Update (TAU) to register its presence in the new system. To enable the MME in EPS to retrieve the UE context from the AMF in 5GS, the UE provides a mapped EPS-GUTI in the RRC connection establishment triggered by the TAU. As shown in FIG. 2, for example, the EPS-GUTI consists both of a part identifying the MME (GUMMEI) (i.e. the AMF in this case) and a part identifying the UE within that MME (M-TMSI), and is constructed from the corresponding parts in the 5G-GUTI according to the mapping rules defined in 3GPP TS 23.003 v15.4.0.

For networks that support both EPS and 5GS, it is expected that a common deployment option will be the combined MME-AMF node, i.e., a node which has MME functionality for LTE and AMF functionality for New Radio (NR). When the UE moves from 5GS to EPS, the eNB will look at the GUMMEI part of the mapped EPS-GUTI and try to route the TAU request to the associated MME (i.e. the combined MME-AMF node). If the eNB lacks S1 connectivity to the associated MME, it will select a new MME randomly which will in turn retrieve the UE context from the source MME over the N26 interface.

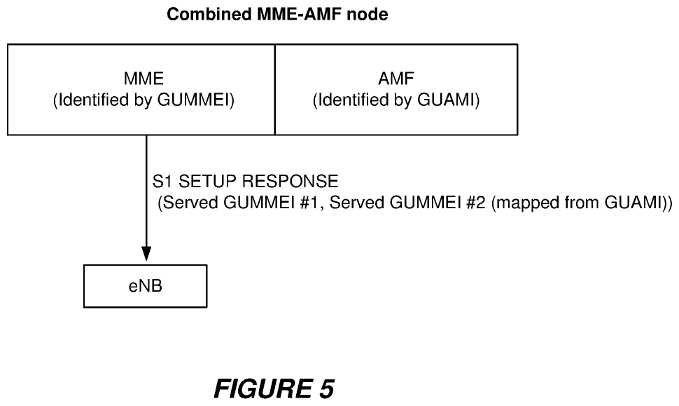

For a combined MME-AMF node, in order to keep a UE within the combined node at mobility from 5GS to EPS, the MME needs to include in the S1 SETUP RESPONSE the identity of the AMF (GUAMI) mapped to a Served GUMMEI (see section 9.1.8.5 in 3GPP TS 36.413 v15.1.0). FIG. 5 in this regard shows this S1 setup during which the MME provides to the eNB an indication of the served GUMMEIs. In particular, the MME of the combined MME-AMF node transmits to an eNB an S1 SETUP RESPONSE that indicates the served GUMMEIs, shown in this example as Served GUMMEI #1 and Served GUMMEI #2. Here, Served GUMMEI #2 is mapped from the GUAMI which identifies the AMF of the combined MME-AMF node.

There currently exist certain challenge(s). The 5GS interworking implies there will be two sets of MME identifiers (GUMMEIs) in the EPS network: native GUMMEIs representing MMEs and which are allocated by the EPS network and mapped GUMMEIs representing AMFs and which are mapped from AMF identifiers (GUAMIs) allocated by the 5GS network. To guarantee proper routing of signaling messages, the GUMMEIs need to be unique which means that that there cannot be any collisions between the native and mapped GUMMEIs. Heretofore, this would in turn mean that MME and AMF identifiers need to be coordinated which complicates network planning.

A similar issue arises for idle mode mobility from 2G/3G to EPS where the GUMMEI can also either be native or mapped from the 2G/3G SGSN identifier. To avoid having to coordinate the MME and SGSN identifiers, the UE indicates using the field gummei-Type in the RRC connection establishment whether the provided GUMMEI is native or mapped. Just indicating the GUMMEI is mapped, however, would not inherently indicate the type of network from which the GUMMEI is mapped. So, while this field could potentially be re-used also for 5GS interworking, the drawback is that it would not allow the network to distinguish between a GUMMEIs mapped from SGSN identifiers and AMF identifiers. This would then imply that the network must coordinate the SGSN and AMF identifiers which is also not ideal.

Certain aspects of the present disclosure and their embodiments may provide solutions to these or other challenges. To support idle mode mobility from 5GS to EPS without having to coordinate the identities between the MMEs and AMFs and between AMFs and SGSNs, a separate indication according to some embodiments is included in RRC connection establishment to indicate the GUMMEI is mapped from an AMF identifier. This can for example be done by extending the gummeiType field with a new value mappedFrom5G.

Furthermore, to enable the eNB to route the UE to the correct MME, the MME in some embodiments will indicate in the S1 setup which Served GUMMEIs are native and thus corresponds to MMEs, and which ones are mapped from AMF identifiers and thus corresponds to AMFs. This can for example be done by providing separate lists with the native and mapped GUMMEIs. When routing the UE, the eNB selects an MME from the list corresponding to the type of GUMMEI indicated by the UE in the RRC connection establishment.

According to some embodiments, the MME provides a separation of Served GUMMEIs which are native and Served GUMMEIs which are mapped from SGSN identifiers in the S1 setup. And the MME also provides an additional separation of Served GUMMEIs which are mapped from AMF identifiers, e.g. in a separate list or a delimiter in the existing list.

To make it backward compatible for networks using legacy eNBs and/or legacy MMEs, and in which the SGSN, MME and AMF identifiers are coordinated, the Served GUMMEIs which are mapped from AMF identifiers should in such cases also (upgraded MME and legacy eNB) or instead (legacy MME) be included in the legacy list of mapped Served GUMMEIs. In that way, AMF(s) may still be associated to the MME but it requires coordination of SGSN, MME and AMF addresses.

Certain embodiments may provide one or more of the following technical advantage(s). According to some embodiments, idle mode mobility from 5GS to EPS can be supported without having to coordinate the core network identities used in 5GS and EPS or the core network identities used in 5GS and 2G/3G. This simplifies network planning and means more core network nodes/identities can be supported since each system have access to the full identity space when allocating core network identifies.

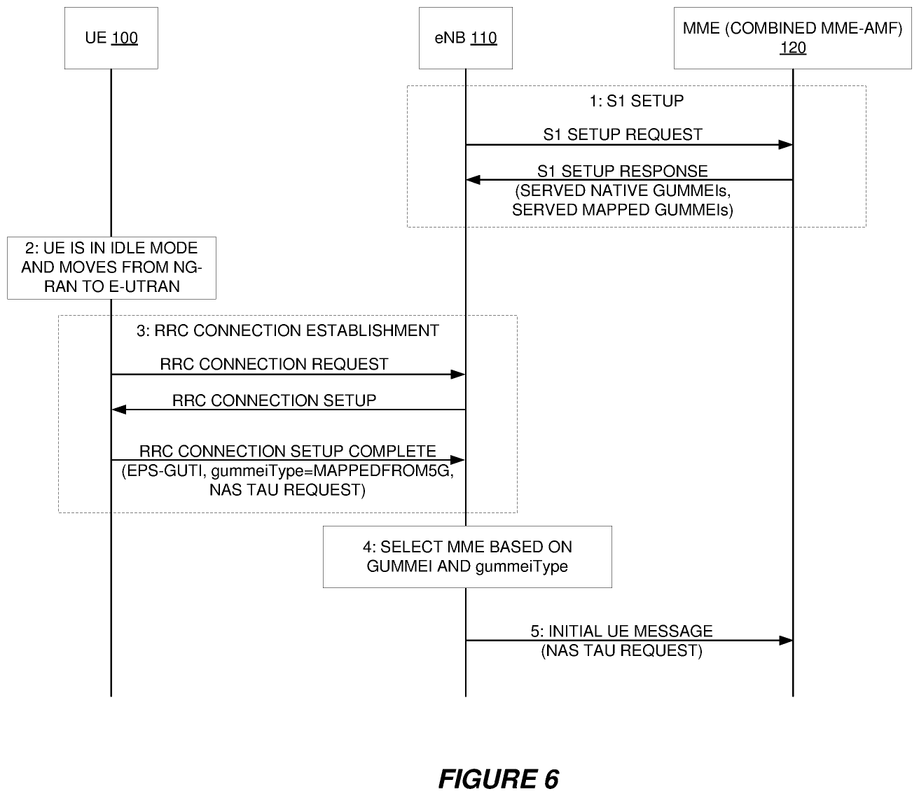

FIG. 6 illustrates steps of some embodiments for idle mode mobility from 5GS to EPS. As shown, an eNB 110 in Step 1 performs S1 setup with an MME 120, which is assumed to be a combined MME-AMF. Upon establishment of the S1 connection between the eNB 110 and the MME 120, the MME 120 in the S1 setup response provides the eNB 110 with the set of Served GUMMEIs and also indicates which of the Served GUMMEI are native and thus corresponds MMEs and which served GUMMEIs are mapped from AMF identifiers and thus corresponds to AMFs. This can for example be done by providing separate lists for the native and mapped GUMMEIs or a delimiter in the existing list.

Note that in case of a combined MME-AMF-SGSN, the MME 120 may also provide an additional list containing the Served GUMMEIs that have been mapped from an SGSN identifier or a delimiter in the existing list.

To enable the eNB 110 to identify which list contains the native GUMMEIs, GUMMEIs mapped from AMF identifiers, and GUMMEIs mapped from SGSN identifiers, a simple rule could be defined saying that the first list contains GUMMEIs of the first type, the second list contains GUMMEIs of the second type, and the third list contains GUMMEIs of the third type. Another possibility is to tag each list with the type of GUMMEIs which are contained in the list. A combination of these two solutions is also possible. Current GUMMEI list states that the first in the list is a native LTE GUMMEI and the following are mapped GUMMEIs i.e. mapped from SGSN identifier. Some embodiments add a separate list for GUMMEIs mapped from AMF identifiers or add the GUMMEIs mapped from AMF identifiers to the existing list and let the MME 120 provide a delimiter enabling the eNB 110 to be aware of which are the GUMMEIs mapped from the AMF identifiers.

In Step 2 of FIG. 6, the UE 100 in idle mode moves from NG-RAN to E-UTRAN. When the UE 100 does this, the NAS layer in the UE 100 will trigger a tracking area update (TAU) procedure to register the UE 100 in EPS and to allow EPS to retrieve the UE context from 5GS.

As shown in Step 3 of FIG. 6, the TAU will in turn trigger the access stratum (AS) layer in the UE 100 in to perform an RRC connection establishment. The UE includes in the RRC connection setup complete message the EPS-GUTI mapped from the 5G-GUTI which was previously assigned to the UE in 5GS. The mapped EPS-GUTI is sent together with the TAU request in the RRC connection setup complete message, which is the third and final step of the RRC connection establishment procedure. This message also includes an indication that the GUMMEI part of the EPS-GUTI was mapped from 5G-GUTI. In this example, this is done by extending the existing gummei-Type field with the new value mappedFrom5G.

Due to ASN.1 compatibility, a UE that uses the extended gummeiType field may also be required to set the legacy gummeiType field to the value mapped. In this way a legacy eNB which is not able to parse the new field will treat the GUMMEI as GUMMEI mapped from 2G/3G identifiers. It will then be up the MME/network planner to ensure that there are no collisions between the GUMMEIs mapped from 5G and the GUMMEIs mapped from 2G/3G. The MME 120 will also need to ensure that the GUMMEIs mapped from AMF identifiers are included in the list of GUMMEIs mapped from SGSN identifiers (see step 1).

Instead of extending the gummei-Type field, another possibility is to include a completely new field in the RRC connection establishment containing the indication. Yet another possibility is to use an implicit indication where the GUMMEI type is determined based on some other field in the RRC connection establishment which is only provided during idle mode mobility from 5GS to EPS.

In any event, as shown in Step 4, the eNB 110 determines which MME to route the TAU request based on the GUMMEI part of the EPS-GUTI and the gummeiType provided in Step 3. In this case, since the gummeiType is set to mappedFrom5G, the eNB 110 searches for a matching GUMMEI in the list containing GUMMEIs mapped from AMF identifiers and which was provided to the eNB 110 in Step 1. Provided a match is found, the TAU request will be routed to the associated MME.

Note that if no match is found, the eNB lacks S1 connectivity to the combined MME-AMF node which means that the UE 100 has moved outside the area served by the combined MME-AMF node. In such case, the eNB 110 will randomly select an MME from the MMEs that it is connected to. The new MME will then need to fetch the UE context from the old combined MME-AMF node over the N26 interface using the mapped EPS-GUTI.

Finally, in Step 5, the eNB 110 forwards the TAU request to the selected MME.

Although FIG. 6 illustrated some with respect to tracking area update (TAU), embodiments herein generally apply for any sort of access stratum (AS) signaling. Some embodiments therefore generally clarify what the UE indicates in AS signaling, e.g., when the UE issues an Attach or TAU request using mapped identities from 5G. Including an indication that a GUMMEI is mapped from a 5G-GUTI on the AS may advantageously allow the eNB to be able to route signaling from a UE to the MME associated to the UE's old AMF. The UE in this case should thereby in addition to indicating that it is a mapped GUMMEI also indicate if the GUMMEI is mapped from a 5G-GUTI; otherwise, the UE may be routed to an MME associated to an SGSN matching the mapped GUMMEI. And, if the UE were to indicate a native GUMMEI on AS, such would likewise introduce a risk of being routed to an MME matching the GUMMEI and not to the MME associated to the old AMF. Accordingly, some embodiments support interworking between 5GS and 2G/3G in a way that allows the systems to be able to co-exist in the same PLMN, avoids the need for address coordination between SGSNs and AMFs, and/or allows separating the address space for core network entities between SGSNs, MMEs, and AMFs.

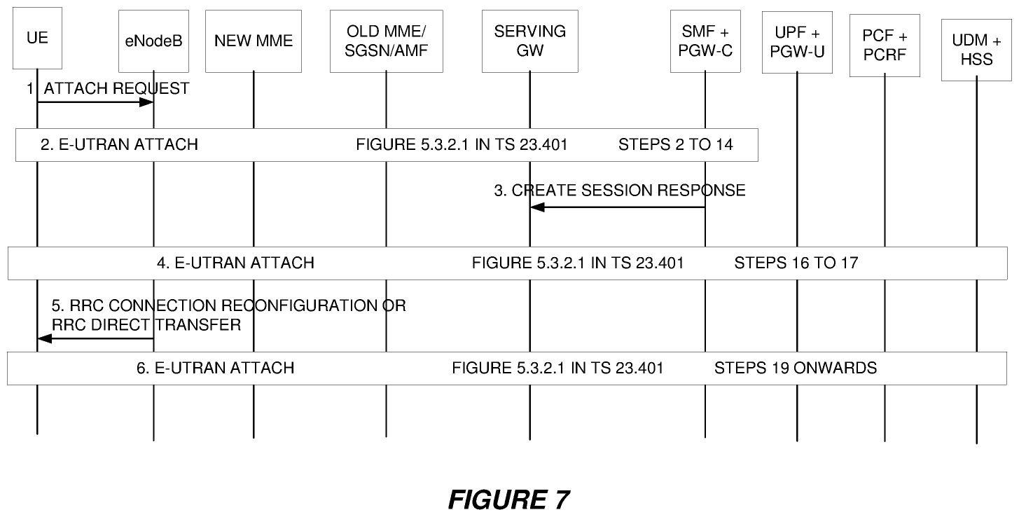

FIG. 7 more specifically shows how the E-UTRAN initial Attach procedure may be impacted when interworking with 5GS using the N26 interface is supported. As shown, the UE in Step 1 sends an Attach Request message. If the UE was previously registered in 5GS, the UE provides in Access Stratum signalling a GUMMEI mapped from the 5G-GUTI and indicates it both as ‘Mapped’ and as ‘Mapped from 5G-GUTI’. If the UE was previously registered in 5GS, the UE provides, in the Attach Request message, an EPS GUTI mapped from 5G-GUTI sent as old Native GUTI and indicates that it is moving from 5GC. A UE that supports 5GC NAS procedures shall indicate its support of 5G NAS as part of its UE Core Network Capability IE. If the UE includes EPS Session Management (ESM) message container for Packet Data Network (PDN) Connection Establishment and the Request type is “initial request”, the UE shall allocate a Packet Data Session (PDU) Session ID and include it in the Protocol Configuration Options (PCO). The PDU Session ID shall be unique across all other PDN connections of the UE.

In Step 2, the relevant steps of E-UTRAN attached are executed, e.g., as specified in TS 23.401.

In Step 3, the Session Management Function (SMF) (as combined with the Packet Gateway Control Plane, PGW-C) sends a Create Session Response to the Serving Gateway (GW). The PGW-C+SMF allocates 5G Quality of Service (QoS) parameters corresponding to the PDN connection, e.g. Session Aggregated Maximum Bit-Rate (AMBR), QoS rules and QoS Flow level QoS parameters if needed for the QoS Flow associated with the QoS rule(s), and then includes them in PCO.

In Step 4, other steps of the E-UTRAN attach procedure are executed, e.g., as specified in TS 23.401.

In Step 5, the eNodeB transmits an RRC Connection Reconfiguration or RRC Direct Transfer to the UE. The 5G QoS parameters for the PDU session and for the QoS Flow associated with the default QoS rule are stored in the UE.

In Step 6, still other steps of the E-UTRAN attach procedure are executed, e.g., as specified in TS 23.401.

Consider now the tracking area update procedure with Serving GW change, e.g., as described in TS 23.401 clause 5.3.3.1. The UE shall in Access Stratum signalling include a GUMMEI that is mapped from 5G-GUTI following the mapping rules specified in TS 23.501 and indicate it both as ‘Mapped’ and as ‘Mapped from 5G-GUTI’. The UE shall, in the TAU request message, include EPS GUTI that is mapped from 5G-GUTI following the mapping rules specified in TS 23.501. The UE indicates that it is moving from SGC. The UE integrity protects the TAU request message using the 5G security context.

In the TAU procedure, the message Context Response may include new information Return preferred. Return preferred is an indication by the AMF of a preferred return of the UE to the last used 5GS PLMN at a later access change to a 5GS shared network. The MME may store the last used 5GS PLMN ID in UE's MM Context. The MME may provide E-UTRAN with a Handover Restriction List taking into account the last used 5GS PLMN ID and the Return Preferred indication. The Handover Restriction List contains a list of PLMN IDs as specified by TS 23.251.

The HSS/UDM de-registers any old AMF node by sending an Nudm_UECM_DeregistrationNotification service operation to the registered AMF for 3GPP access. The registered AMF for 3GPP access initiates AM Policy Association Termination procedure.

The MME may provide the eNodeB with a PLMN list as part of the TAU procedure execution and the procedure signaling from MME to eNodeB. The Handover Restriction List contains a list of PLMN IDs as specified by TS 23.251 clause 5.2a for eNodeB functions.

Regarding MME processing of the partial Tracking Area Update (TAU) procedure, the MME may use an indication Return preferred from Context Response when deciding the PLMN list content. The MME may provide the eNodeB with a PLMN list. The Handover Restriction List contains a list of PLMN IDs as specified by TS 23.501.

Accordingly, some embodiments address the handling of the mapped GUMMEI during idle mode mobility from 5GS to EPS. Some embodiments for example propose to extend the gummei-Type field with the new value mappedFrom5G to indicate that the GUMMEI was mapped from an AMF identifier (GUAMI). This simplifies the planning of the 4G and 5G network as the GUMMEI and GUAMI identity spaces become independent and do not need to be coordinated. And the combined MME-AMF will provide separate lists for the native GUMMEIs and mapped GUMMEIs when it indicates the served GUMMEIs to the eNB in the S1 SETUP RESPONSE. Based on the gummei-Type indicated by the UE, the eNB knows which list to use when it routes the TAU request.

More specifically, then, to avoid having to coordinate the core network (CN) identities used in 5GS and EPS and the CN identities used in 5GS and 2G/3G, the UE indicates whether the MME identifier (GUMMEI) provided in the RRC connection establishment is native, mapped from a 2G/3G SGSN identifier (RAI), or mapped from a 5GS AMF identifier (GUAMI). For example, the gummei-Type field in the RRCConnectionSetupComplete message is in some embodiments extended with a new value mappedFrom5G to indicate that the GUMMEI was mapped from a GUAMI.

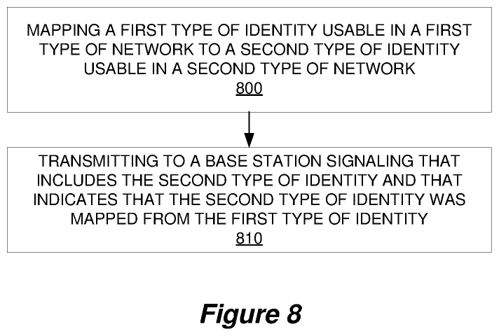

In view of the modifications and variations herein, FIG. 8 depicts a method performed by a wireless device 10 in accordance with particular embodiments. The method includes mapping a first type of identity ID1 usable in a first type of network 20 to a second type of identity ID2 usable in a second type of network 30 (Block 800). In some embodiments, the second type of identity ID2 is mappable from any one of multiple different possible types of identities usable in different respective types of wireless communication networks, e.g., a 5G network and a 2G/3G network. These multiple different possible types of identities may include the first type of identity ID1. The method also includes transmitting, e.g., to a base station 36, signaling 60 that includes the second type of identity ID2 and that indicates the second type of identity ID2 was mapped from the first type of identity ID1 (Block 810). By indicating that the second type of identity ID2 was mapped from the first type of identity ID1, the signaling 60 may thereby indicate the type of identity, from among the multiple different types of identities, from which the second type of identity ID2 is mapped.

In some embodiments, the first type of identity is or includes a first type of network node identity that identifies a network node 22 in the first type of network 20. For example, the network node 22 in the first type of network 20 may be an access and mobility function (AMF), in which case the first type of network node identity may be a globally unique AMF identity (GUAMI). In these or other embodiments, the first type of identity ID1 may identify a network node 22 in the first type of network 20 that has a context 10A for the wireless device 10 and/or with which the wireless device 10 is registered.

Alternatively or additionally, the second type of identity in some embodiments is or includes a second type of network node identity usable to identify a network node in the second type of network 30. For example, the network node in the second type of network 20 may be a mobility management entity (MME), in which case the second type of network node identity may be a globally unique MME identity (GUMMED.

In any of the above embodiments, the first type of identity ID1 may be a 5G identity and the first type of network 20 may be a 5G network. Alternatively or additionally, the second type of identity ID2 may be an Evolved Packet System (EPS) identity and the second type of network 30 may be an EPS network.

In other embodiments, the first type of identity ID1 is a 5G globally unique temporary identity (5G-GUTI), and the first type of network 20 is a 5G network. Alternatively or additionally, the second type of identity ID2 in some embodiments is an evolved packet system (EPS) globally unique temporary identity (EPS-GUTI), and the second type of network 30 is an EPS network.

In any of the above embodiments, the signaling 60 may be access stratum (AS) signaling. Alternatively or additionally, the signaling 60 may be an attach request message transmitted to radio network equipment 36 in the second type of network 30. In other embodiments, the signaling 60 is a tracking area update request message. Alternatively or additionally, the signaling 60 is a message transmitted as part of a procedure to establish a radio resource control, RRC, connection. The signaling may for instance be an RRC connection setup complete message. In this case, in some embodiments, a GUMMEI type field in the RRC connection setup complete message includes at least one possible value that indicates the second type of identity ID2 was mapped from the first type of identity ID1. In some embodiments, the GUMMEI type field in the RRC connection complete message also includes a possible value that indicates the second type of identity was mapped from another type of identity but does not indicate which type of identity.

In other embodiments, the signaling 60 comprises an RRC connection setup complete message that includes a GUMMEI type field with a first possible value which indicates the second type of identity ID2 is mapped from a 5G identifier and a second possible value which indicates the second type of identity ID2 is mapped from a 2G or 3G identifier. In this case, where the first type of identifier is a 5G identifier, the GUMMEI type field as transmitted by the wireless device may have the first possible value to indicate the second type of identifier ID2 is mapped from a 5G identifier.

In some embodiments, the signaling 60 is transmitted while the wireless device 10 is in idle mode or RRC idle mode.

In some embodiments, the method further comprises performing a procedure associated with mobility of the wireless device 10 from the first type of wireless communication network 20 to the second type of wireless communication network 30. In one such embodiment, the signaling 60 is transmitted from the wireless device 10 as part of the procedure.

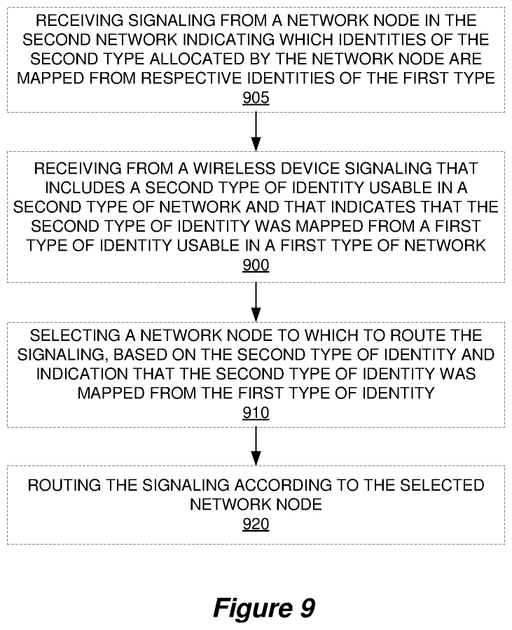

FIG. 9 depicts a method performed by a base station in accordance with other particular embodiments. The method in some embodiments includes receiving, from a network node in a second type of network 30, signaling indicating which identities of a second type allocated by the network node are mapped from respective identities of a first type usable in a first type of network 20 (Block 905). In some embodiments, the second type of identity ID2 is mappable from any one of multiple different possible types of identities usable in different respective types of wireless communication networks, e.g., a 5G network and a 2G/3G network. The multiple different possible types of identities in this case include the first type of identity ID2.

In some embodiments, the multiple different possible types of identities further include a third type of identity usable in a third type of wireless communication network. For example, the third type of identity may be an SGSN identity usable in a 2G or 3G network. Regardless, the method may also comprise transmitting signaling indicating which identities of the second type are mapped from respective identities of the third type.

In some embodiments, the signaling comprises a list of the identities of the second type allocated by the network node and mapped from respective identities of the first type.

In some embodiments, the signaling also indicates which identities of the second type allocated by the network node are native to the second network.

In some embodiments, the signaling is included in an S1 setup response message.

Alternatively or additionally, the method may include receiving from a wireless device 10 signaling 60 that includes a second type of identity ID2 usable in a second type of network 30 and that indicates that the second type of identity ID2 was mapped from a first type of identity ID1 usable in a first type of network 20 (Block 900). In some embodiments, the second type of identity ID2 is mappable from any one of multiple different possible types of identities usable in different respective types of wireless communication networks, e.g., a 5G network and a 2G/3G network. These multiple different possible types of identities may include the first type of identity ID1. In this case, then, by indicating the second type of identity ID2 was mapped from the first type of identity ID1, the signaling 60 may thereby indicate the type of identity, from among the multiple different types of identities, from which the second type of identity ID2 is mapped.

In either case, in some embodiments, the method includes selecting a network node 22 to which to route the signaling 60, based on the second type of identity ID and indication 62 that the second type of identity ID2 was mapped from the first type of identity ID1 (Block 910). The method may further include routing the signaling 60 according to the selected network node (Block 920).

In some embodiments, the first type of identity is or includes a first type of network node identity that identifies a network node 22 in the first type of network 20. For example, the network node 22 in the first type of network 20 may be an access and mobility function (AMF), in which case the first type of network node identity may be a globally unique AMF identity (GUAMI). In these or other embodiments, the first type of identity ID1 may identify a network node 22 in the first type of network 20 that has a context 10A for the wireless device 10 and/or with which the wireless device 10 is registered. In this case, the method in some embodiments further comprises attempting to retrieve the context 10A for the wireless device 10 from the network node 22.

Alternatively or additionally, the second type of identity in some embodiments is or includes a second type of network node identity usable to identify a network node in the second type of network 30. For example, the network node in the second type of network 20 may be a mobility management entity (MME), in which case the second type of network node identity may be a globally unique MME identity (GUMMED.

In any of the above embodiments, the first type of identity ID1 may be a 5G identity and the first type of network 20 may be a 5G network. Alternatively or additionally, the second type of identity ID2 may be an Evolved Packet System (EPS) identity and the second type of network 30 may be an EPS network.

In other embodiments, the first type of identity ID1 is a 5G globally unique temporary identity (5G-GUTI), and the first type of network 20 is a 5G network. Alternatively or additionally, the second type of identity ID2 in some embodiments is an evolved packet system (EPS) globally unique temporary identity (EPS-GUTI), and the second type of network 30 is an EPS network.

In any of the above embodiments, the signaling 60 may be access stratum (AS) signaling. Alternatively or additionally, the signaling 60 may be an attach request message transmitted to radio network equipment 36 in the second type of network 30. In other embodiments, the signaling 60 is a tracking area update request message. Alternatively or additionally, the signaling 60 is a message transmitted as part of a procedure to establish a radio resource control, RRC, connection. The signaling may for instance be an RRC connection setup complete message. In this case, in some embodiments, a GUMMEI type field in the RRC connection setup complete message includes at least one possible value that indicates the second type of identity ID2 was mapped from the first type of identity ID1. In some embodiments, the GUMMEI type field in the RRC connection complete message also includes a possible value that indicates the second type of identity was mapped from another type of identity but does not indicate which type of identity.

In other embodiments, the signaling 60 comprises an RRC connection setup complete message that includes a GUMMEI type field with a first possible value which indicates the second type of identity ID2 is mapped from a 5G identifier and a second possible value which indicates the second type of identity ID2 is mapped from a 2G or 3G identifier. In this case, where the first type of identifier is a 5G identifier, the GUMMEI type field as transmitted by the wireless device may have the first possible value to indicate the second type of identifier ID2 is mapped from a 5G identifier.

In some embodiments, the signaling 60 is transmitted while the wireless device 10 is in idle mode or RRC idle mode.

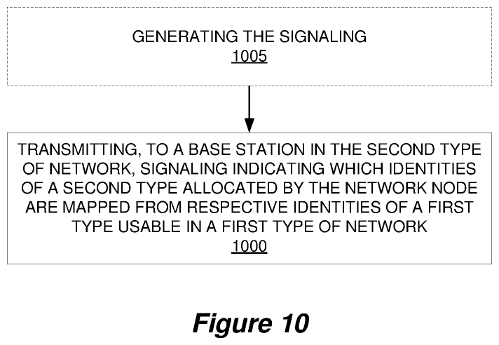

FIG. 10 depicts a method performed by a network node (e.g., an MME or AMF) in accordance with other particular embodiments. The method includes transmitting, to a base station in the second type of network 30, signaling indicating which identities of a second type allocated by the network node are mapped from respective identities of a first type usable in a first type of network 20 (Block 1000). In some embodiments, the second type of identity ID2 is mappable from any one of multiple different possible types of identities usable in different respective types of wireless communication networks, e.g., a 5G network and a 2G/3G network. The multiple different possible types of identities in this case include the first type of identity ID2. Regardless, the method in some embodiments may also include generating the signaling (Block 1005).

In some embodiments, the multiple different possible types of identities further include a third type of identity usable in a third type of wireless communication network. For example, the third type of identity may be an SGSN identity usable in a 2G or 3G network. Regardless, the method may also comprise transmitting signaling indicating which identities of the second type are mapped from respective identities of the third type.

In some embodiments, the signaling comprises a list of the identities of the second type allocated by the network node and mapped from respective identities of the first type.

In some embodiments, the signaling also indicates which identities of the second type allocated by the network node are native to the second network.

In some embodiments, the signaling is included in an S1 setup response message.

In some embodiments, the first type of identity ID1 is or includes a first type of network node identity that identifies a network node 22 in the first type of network 20. For example, the network node 22 in the first type of network 20 may be an access and mobility function (AMF), in which case the first type of network node identity may be a globally unique AMF identity (GUAMI). In these or other embodiments, the first type of identity ID1 may identify a network node 22 in the first type of network 20 that has a context 10A for the wireless device 10 and/or with which the wireless device 10 is registered.

Alternatively or additionally, the second type of identity ID2 in some embodiments is or includes a second type of network node identity usable to identify a network node in the second type of network 30. For example, the network node in the second type of network 20 may be a mobility management entity (MME), in which case the second type of network node identity may be a globally unique MME identity (GUMMEI).

In any of the above embodiments, the first type of identity ID1 may be a 5G identity and the first type of network 20 may be a 5G network. Alternatively or additionally, the second type of identity ID2 may be an Evolved Packet System (EPS) identity and the second type of network 30 may be an EPS network.

In other embodiments, the first type of identity ID1 is a 5G globally unique temporary identity (5G-GUTI), and the first type of network 20 is a 5G network. Alternatively or additionally, the second type of identity ID2 in some embodiments is an evolved packet system (EPS) globally unique temporary identity (EPS-GUTI), and the second type of network 30 is an EPS network.

Note that the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

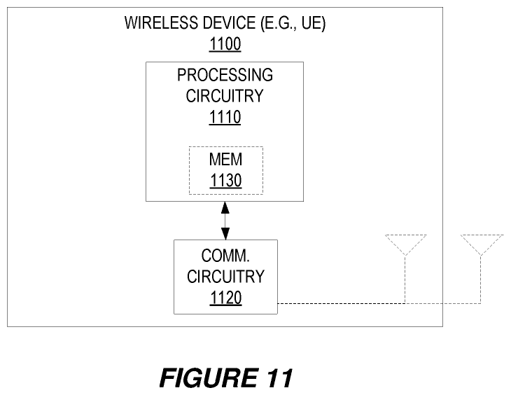

FIG. 11 for example illustrates a wireless device 1100, e.g., wireless device 10, as implemented in accordance with one or more embodiments. As shown, the wireless device 1100 includes processing circuitry 1110 and communication circuitry 1120. The communication circuitry 1120 (e.g., radio circuitry) is configured to transmit and/or receive information to and/or from one or more other nodes, e.g., via any communication technology. Such communication may occur via one or more antennas that are either internal or external to the wireless device 1100. The processing circuitry 1110 is configured to perform processing described above, such as by executing instructions stored in memory 1130. The processing circuitry 1110 in this regard may implement certain functional means, units, or modules.

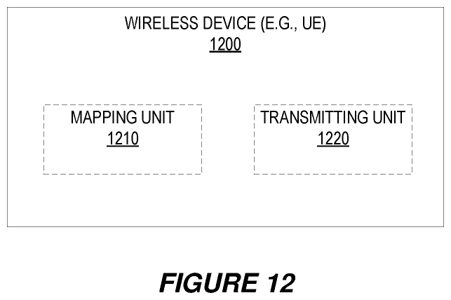

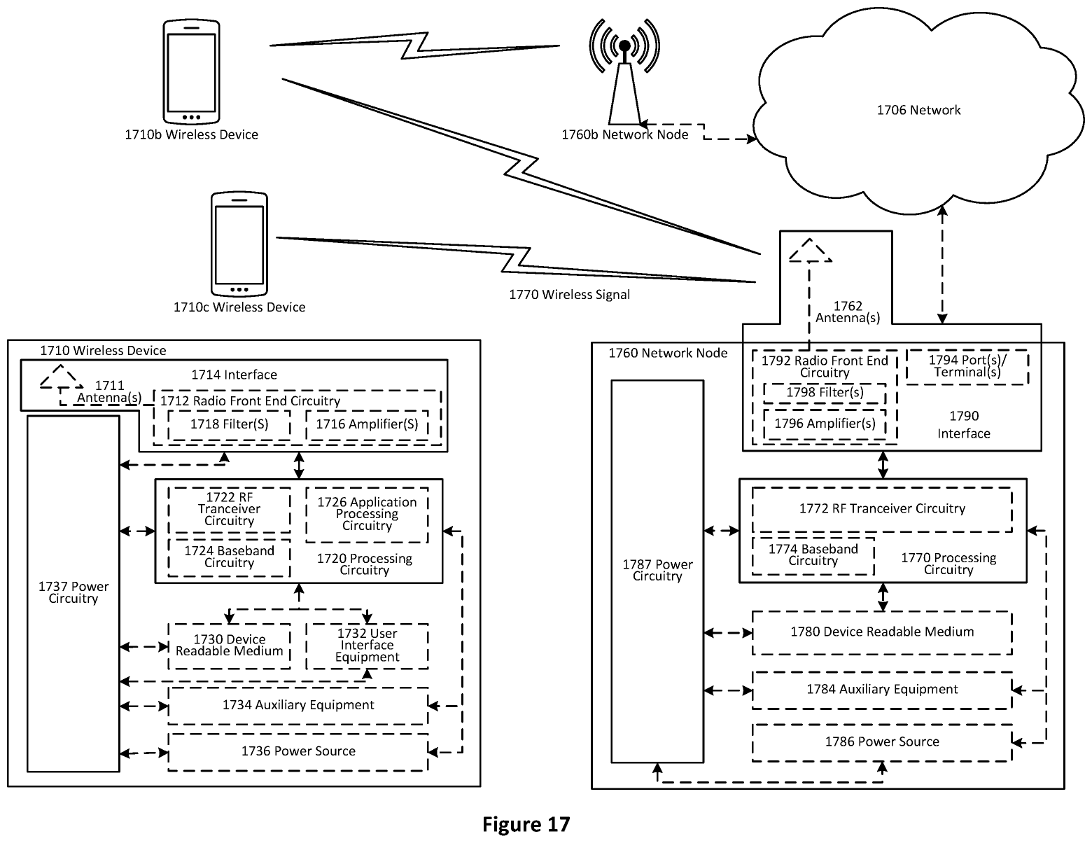

FIG. 12 illustrates a schematic block diagram of a wireless device 1200, e.g., wireless device 10, in a wireless network according to still other embodiments (for example, the wireless network shown in FIG. 17). As shown, the wireless device 1200 implements various functional means, units, or modules, e.g., via the processing circuitry 1110 in FIG. 11 and/or via software code. These functional means, units, or modules, e.g., for implementing the method(s) herein, include for instance a mapping unit 1210 for performing the mapping step in FIG. 8 and a transmitting unit 1220 for performing the transmitting step in FIG. 8.

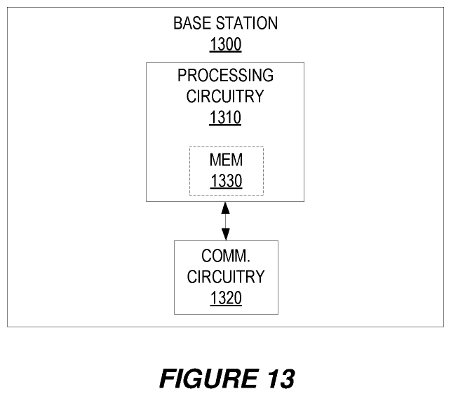

FIG. 13 illustrates a base station 1300, e.g., as one form of radio network node 36, as implemented in accordance with one or more embodiments. As shown, the base station 1300 includes processing circuitry 1310 and communication circuitry 1320. The communication circuitry 1320 is configured to transmit and/or receive information to and/or from one or more other nodes, e.g., via any communication technology. The processing circuitry 1310 is configured to perform processing described above, such as by executing instructions stored in memory 1330. The processing circuitry 1310 in this regard may implement certain functional means, units, or modules.

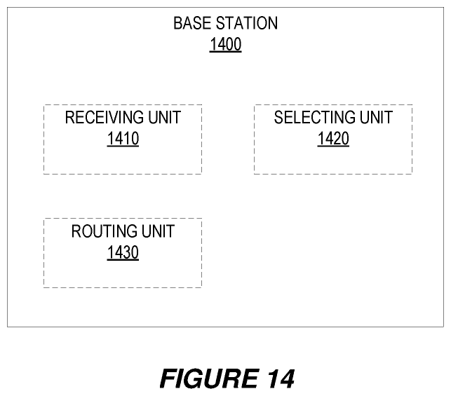

FIG. 14 illustrates a schematic block diagram of a base station 1400, e.g., as one form of radio network node 36, in a wireless network according to still other embodiments (for example, the wireless network shown in FIG. 17). As shown, the base station 1400 implements various functional means, units, or modules, e.g., via the processing circuitry 1310 in FIG. 13 and/or via software code. These functional means, units, or modules, e.g., for implementing the method(s) herein, include for instance a receiving unit 1410 for performing the receiving step(s) in FIG. 9, a selecting unit 1420 for performing the selecting step in FIG. 9, and/or a routing unit 1430 for performing the routing step in FIG. 9.

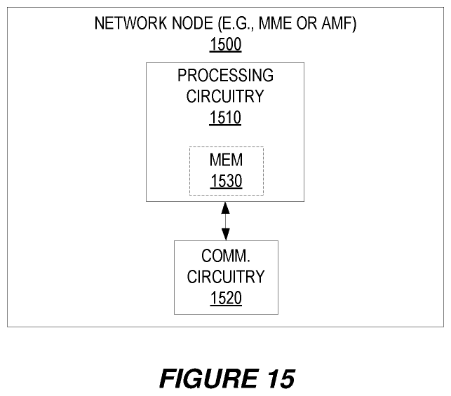

FIG. 15 illustrates a network node 1500, e.g., network node 22 such as an MME or AMF, as implemented in accordance with one or more embodiments. As shown, the network node 1500 includes processing circuitry 1510 and communication circuitry 1520. The communication circuitry 1520 is configured to transmit and/or receive information to and/or from one or more other nodes, e.g., via any communication technology. The processing circuitry 1510 is configured to perform processing described above, such as by executing instructions stored in memory 1530. The processing circuitry 1510 in this regard may implement certain functional means, units, or modules.

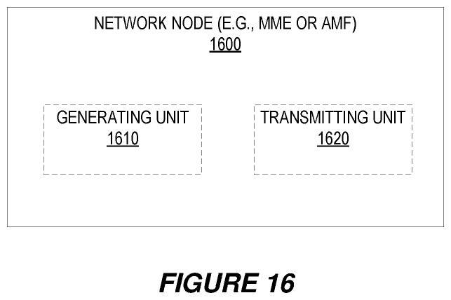

FIG. 16 illustrates a schematic block diagram of network node, e.g., network node 22 such as an MME or AMF, in a wireless network according to still other embodiments (for example, the wireless network shown in FIG. 17). As shown, the network node 1600 implements various functional means, units, or modules, e.g., via the processing circuitry 1310 in FIG. 15 and/or via software code. These functional means, units, or modules, e.g., for implementing the method(s) herein, include for instance a transmitting unit 1620 for performing the transmitting step in FIG. 10. Also included may be a generating unit 1610 for performing the generating step in FIG. 10.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

Although the subject matter described herein may be implemented in any appropriate type of system using any suitable components, the embodiments disclosed herein are described in relation to a wireless network, such as the example wireless network illustrated in FIG. 17. For simplicity, the wireless network of FIG. 17 only depicts network 1706, network nodes 1760 and 1760b, and WDs 1710, 1710b, and 1710c. In practice, a wireless network may further include any additional elements suitable to support communication between wireless devices or between a wireless device and another communication device, such as a landline telephone, a service provider, or any other network node or end device. Of the illustrated components, network node 1760 and wireless device (WD) 1710 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1706 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1760 and WD 1710 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 17, network node 1760 includes processing circuitry 1770, device readable medium 1780, interface 1790, auxiliary equipment 1784, power source 1786, power circuitry 1787, and antenna 1762. Although network node 1760 illustrated in the example wireless network of FIG. 17 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1760 are depicted as single boxes located within a larger box, or nested within multiple boxes, in practice, a network node may comprise multiple different physical components that make up a single illustrated component (e.g., device readable medium 1780 may comprise multiple separate hard drives as well as multiple RAM modules).

Similarly, network node 1760 may be composed of multiple physically separate components (e.g., a NodeB component and a RNC component, or a BTS component and a BSC component, etc.), which may each have their own respective components. In certain scenarios in which network node 1760 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1760 may be configured to support multiple radio access technologies (RATs). In such embodiments, some components may be duplicated (e.g., separate device readable medium 1780 for the different RATs) and some components may be reused (e.g., the same antenna 1762 may be shared by the RATs). Network node 1760 may also include multiple sets of the various illustrated components for different wireless technologies integrated into network node 1760, such as, for example, GSM, WCDMA, LTE, NR, WiFi, or Bluetooth wireless technologies. These wireless technologies may be integrated into the same or different chip or set of chips and other components within network node 1760.

Processing circuitry 1770 is configured to perform any determining, calculating, or similar operations (e.g., certain obtaining operations) described herein as being provided by a network node. These operations performed by processing circuitry 1770 may include processing information obtained by processing circuitry 1770 by, for example, converting the obtained information into other information, comparing the obtained information or converted information to information stored in the network node, and/or performing one or more operations based on the obtained information or converted information, and as a result of said processing making a determination.

Processing circuitry 1770 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1760 components, such as device readable medium 1780, network node 1760 functionality. For example, processing circuitry 1770 may execute instructions stored in device readable medium 1780 or in memory within processing circuitry 1770. Such functionality may include providing any of the various wireless features, functions, or benefits discussed herein. In some embodiments, processing circuitry 1770 may include a system on a chip (SOC).

In some embodiments, processing circuitry 1770 may include one or more of radio frequency (RF) transceiver circuitry 1772 and baseband processing circuitry 1774. In some embodiments, radio frequency (RF) transceiver circuitry 1772 and baseband processing circuitry 1774 may be on separate chips (or sets of chips), boards, or units, such as radio units and digital units. In alternative embodiments, part or all of RF transceiver circuitry 1772 and baseband processing circuitry 1774 may be on the same chip or set of chips, boards, or units

In certain embodiments, some or all of the functionality described herein as being provided by a network node, base station, eNB or other such network device may be performed by processing circuitry 1770 executing instructions stored on device readable medium 1780 or memory within processing circuitry 1770. In alternative embodiments, some or all of the functionality may be provided by processing circuitry 1770 without executing instructions stored on a separate or discrete device readable medium, such as in a hard-wired manner. In any of those embodiments, whether executing instructions stored on a device readable storage medium or not, processing circuitry 1770 can be configured to perform the described functionality. The benefits provided by such functionality are not limited to processing circuitry 1770 alone or to other components of network node 1760, but are enjoyed by network node 1760 as a whole, and/or by end users and the wireless network generally.

Device readable medium 1780 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1770. Device readable medium 1780 may store any suitable instructions, data or information, including a computer program, software, an application including one or more of logic, rules, code, tables, etc. and/or other instructions capable of being executed by processing circuitry 1770 and, utilized by network node 1760. Device readable medium 1780 may be used to store any calculations made by processing circuitry 1770 and/or any data received via interface 1790. In some embodiments, processing circuitry 1770 and device readable medium 1780 may be considered to be integrated.

Interface 1790 is used in the wired or wireless communication of signalling and/or data between network node 1760, network 1706, and/or WDs 1710. As illustrated, interface 1790 comprises port(s)/terminal(s) 1794 to send and receive data, for example to and from network 1706 over a wired connection. Interface 1790 also includes radio front end circuitry 1792 that may be coupled to, or in certain embodiments a part of, antenna 1762. Radio front end circuitry 1792 comprises filters 1798 and amplifiers 1796. Radio front end circuitry 1792 may be connected to antenna 1762 and processing circuitry 1770. Radio front end circuitry may be configured to condition signals communicated between antenna 1762 and processing circuitry 1770. Radio front end circuitry 1792 may receive digital data that is to be sent out to other network nodes or WDs via a wireless connection. Radio front end circuitry 1792 may convert the digital data into a radio signal having the appropriate channel and bandwidth parameters using a combination of filters 1798 and/or amplifiers 1796. The radio signal may then be transmitted via antenna 1762. Similarly, when receiving data, antenna 1762 may collect radio signals which are then converted into digital data by radio front end circuitry 1792. The digital data may be passed to processing circuitry 1770. In other embodiments, the interface may comprise different components and/or different combinations of components.

In certain alternative embodiments, network node 1760 may not include separate radio front end circuitry 1792, instead, processing circuitry 1770 may comprise radio front end circuitry and may be connected to antenna 1762 without separate radio front end circuitry 1792. Similarly, in some embodiments, all or some of RF transceiver circuitry 1772 may be considered a part of interface 1790. In still other embodiments, interface 1790 may include one or more ports or terminals 1794, radio front end circuitry 1792, and RF transceiver circuitry 1772, as part of a radio unit (not shown), and interface 1790 may communicate with baseband processing circuitry 1774, which is part of a digital unit (not shown).

Antenna 1762 may include one or more antennas, or antenna arrays, configured to send and/or receive wireless signals. Antenna 1762 may be coupled to radio front end circuitry 1790 and may be any type of antenna capable of transmitting and receiving data and/or signals wirelessly. In some embodiments, antenna 1762 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1762 may be separate from network node 1760 and may be connectable to network node 1760 through an interface or port.

Antenna 1762, interface 1790, and/or processing circuitry 1770 may be configured to perform any receiving operations and/or certain obtaining operations described herein as being performed by a network node. Any information, data and/or signals may be received from a wireless device, another network node and/or any other network equipment. Similarly, antenna 1762, interface 1790, and/or processing circuitry 1770 may be configured to perform any transmitting operations described herein as being performed by a network node. Any information, data and/or signals may be transmitted to a wireless device, another network node and/or any other network equipment.

Power circuitry 1787 may comprise, or be coupled to, power management circuitry and is configured to supply the components of network node 1760 with power for performing the functionality described herein. Power circuitry 1787 may receive power from power source 1786. Power source 1786 and/or power circuitry 1787 may be configured to provide power to the various components of network node 1760 in a form suitable for the respective components (e.g., at a voltage and current level needed for each respective component). Power source 1786 may either be included in, or external to, power circuitry 1787 and/or network node 1760. For example, network node 1760 may be connectable to an external power source (e.g., an electricity outlet) via an input circuitry or interface such as an electrical cable, whereby the external power source supplies power to power circuitry 1787. As a further example, power source 1786 may comprise a source of power in the form of a battery or battery pack which is connected to, or integrated in, power circuitry 1787. The battery may provide backup power should the external power source fail. Other types of power sources, such as photovoltaic devices, may also be used.

Alternative embodiments of network node 1760 may include additional components beyond those shown in FIG. 17 that may be responsible for providing certain aspects of the network node's functionality, including any of the functionality described herein and/or any functionality necessary to support the subject matter described herein. For example, network node 1760 may include user interface equipment to allow input of information into network node 1760 and to allow output of information from network node 1760. This may allow a user to perform diagnostic, maintenance, repair, and other administrative functions for network node 1760.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1710 includes antenna 1711, interface 1714, processing circuitry 1720, device readable medium 1730, user interface equipment 1732, auxiliary equipment 1734, power source 1736 and power circuitry 1737. WD 1710 may include multiple sets of one or more of the illustrated components for different wireless technologies supported by WD 1710, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1710.

Antenna 1711 may include one or more antennas or antenna arrays, configured to send and/or receive wireless signals, and is connected to interface 1714. In certain alternative embodiments, antenna 1711 may be separate from WD 1710 and be connectable to WD 1710 through an interface or port. Antenna 1711, interface 1714, and/or processing circuitry 1720 may be configured to perform any receiving or transmitting operations described herein as being performed by a WD. Any information, data and/or signals may be received from a network node and/or another WD. In some embodiments, radio front end circuitry and/or antenna 1711 may be considered an interface.

As illustrated, interface 1714 comprises radio front end circuitry 1712 and antenna 1711. Radio front end circuitry 1712 comprise one or more filters 1718 and amplifiers 1716. Radio front end circuitry 1714 is connected to antenna 1711 and processing circuitry 1720, and is configured to condition signals communicated between antenna 1711 and processing circuitry 1720. Radio front end circuitry 1712 may be coupled to or a part of antenna 1711. In some embodiments, WD 1710 may not include separate radio front end circuitry 1712; rather, processing circuitry 1720 may comprise radio front end circuitry and may be connected to antenna 1711. Similarly, in some embodiments, some or all of RF transceiver circuitry 1722 may be considered a part of interface 1714. Radio front end circuitry 1712 may receive digital data that is to be sent out to other network nodes or WDs via a wireless connection. Radio front end circuitry 1712 may convert the digital data into a radio signal having the appropriate channel and bandwidth parameters using a combination of filters 1718 and/or amplifiers 1716. The radio signal may then be transmitted via antenna 1711. Similarly, when receiving data, antenna 1711 may collect radio signals which are then converted into digital data by radio front end circuitry 1712. The digital data may be passed to processing circuitry 1720. In other embodiments, the interface may comprise different components and/or different combinations of components.

Processing circuitry 1720 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1710 components, such as device readable medium 1730, WD 1710 functionality. Such functionality may include providing any of the various wireless features or benefits discussed herein. For example, processing circuitry 1720 may execute instructions stored in device readable medium 1730 or in memory within processing circuitry 1720 to provide the functionality disclosed herein.

As illustrated, processing circuitry 1720 includes one or more of RF transceiver circuitry 1722, baseband processing circuitry 1724, and application processing circuitry 1726. In other embodiments, the processing circuitry may comprise different components and/or different combinations of components. In certain embodiments processing circuitry 1720 of WD 1710 may comprise a SOC. In some embodiments, RF transceiver circuitry 1722, baseband processing circuitry 1724, and application processing circuitry 1726 may be on separate chips or sets of chips. In alternative embodiments, part or all of baseband processing circuitry 1724 and application processing circuitry 1726 may be combined into one chip or set of chips, and RF transceiver circuitry 1722 may be on a separate chip or set of chips. In still alternative embodiments, part or all of RF transceiver circuitry 1722 and baseband processing circuitry 1724 may be on the same chip or set of chips, and application processing circuitry 1726 may be on a separate chip or set of chips. In yet other alternative embodiments, part or all of RF transceiver circuitry 1722, baseband processing circuitry 1724, and application processing circuitry 1726 may be combined in the same chip or set of chips. In some embodiments, RF transceiver circuitry 1722 may be a part of interface 1714. RF transceiver circuitry 1722 may condition RF signals for processing circuitry 1720.

In certain embodiments, some or all of the functionality described herein as being performed by a WD may be provided by processing circuitry 1720 executing instructions stored on device readable medium 1730, which in certain embodiments may be a computer-readable storage medium. In alternative embodiments, some or all of the functionality may be provided by processing circuitry 1720 without executing instructions stored on a separate or discrete device readable storage medium, such as in a hard-wired manner. In any of those particular embodiments, whether executing instructions stored on a device readable storage medium or not, processing circuitry 1720 can be configured to perform the described functionality. The benefits provided by such functionality are not limited to processing circuitry 1720 alone or to other components of WD 1710, but are enjoyed by WD 1710 as a whole, and/or by end users and the wireless network generally.

Processing circuitry 1720 may be configured to perform any determining, calculating, or similar operations (e.g., certain obtaining operations) described herein as being performed by a WD. These operations, as performed by processing circuitry 1720, may include processing information obtained by processing circuitry 1720 by, for example, converting the obtained information into other information, comparing the obtained information or converted information to information stored by WD 1710, and/or performing one or more operations based on the obtained information or converted information, and as a result of said processing making a determination.

Device readable medium 1730 may be operable to store a computer program, software, an application including one or more of logic, rules, code, tables, etc. and/or other instructions capable of being executed by processing circuitry 1720. Device readable medium 1730 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1720. In some embodiments, processing circuitry 1720 and device readable medium 1730 may be considered to be integrated.

User interface equipment 1732 may provide components that allow for a human user to interact with WD 1710. Such interaction may be of many forms, such as visual, audial, tactile, etc. User interface equipment 1732 may be operable to produce output to the user and to allow the user to provide input to WD 1710. The type of interaction may vary depending on the type of user interface equipment 1732 installed in WD 1710. For example, if WD 1710 is a smart phone, the interaction may be via a touch screen; if WD 1710 is a smart meter, the interaction may be through a screen that provides usage (e.g., the number of gallons used) or a speaker that provides an audible alert (e.g., if smoke is detected). User interface equipment 1732 may include input interfaces, devices and circuits, and output interfaces, devices and circuits. User interface equipment 1732 is configured to allow input of information into WD 1710, and is connected to processing circuitry 1720 to allow processing circuitry 1720 to process the input information. User interface equipment 1732 may include, for example, a microphone, a proximity or other sensor, keys/buttons, a touch display, one or more cameras, a USB port, or other input circuitry. User interface equipment 1732 is also configured to allow output of information from WD 1710, and to allow processing circuitry 1720 to output information from WD 1710. User interface equipment 1732 may include, for example, a speaker, a display, vibrating circuitry, a USB port, a headphone interface, or other output circuitry. Using one or more input and output interfaces, devices, and circuits, of user interface equipment 1732, WD 1710 may communicate with end users and/or the wireless network, and allow them to benefit from the functionality described herein.

Auxiliary equipment 1734 is operable to provide more specific functionality which may not be generally performed by WDs. This may comprise specialized sensors for doing measurements for various purposes, interfaces for additional types of communication such as wired communications etc. The inclusion and type of components of auxiliary equipment 1734 may vary depending on the embodiment and/or scenario.

Power source 1736 may, in some embodiments, be in the form of a battery or battery pack. Other types of power sources, such as an external power source (e.g., an electricity outlet), photovoltaic devices or power cells, may also be used. WD 1710 may further comprise power circuitry 1737 for delivering power from power source 1736 to the various parts of WD 1710 which need power from power source 1736 to carry out any functionality described or indicated herein. Power circuitry 1737 may in certain embodiments comprise power management circuitry. Power circuitry 1737 may additionally or alternatively be operable to receive power from an external power source; in which case WD 1710 may be connectable to the external power source (such as an electricity outlet) via input circuitry or an interface such as an electrical power cable. Power circuitry 1737 may also in certain embodiments be operable to deliver power from an external power source to power source 1736. This may be, for example, for the charging of power source 1736. Power circuitry 1737 may perform any formatting, converting, or other modification to the power from power source 1736 to make the power suitable for the respective components of WD 1710 to which power is supplied.

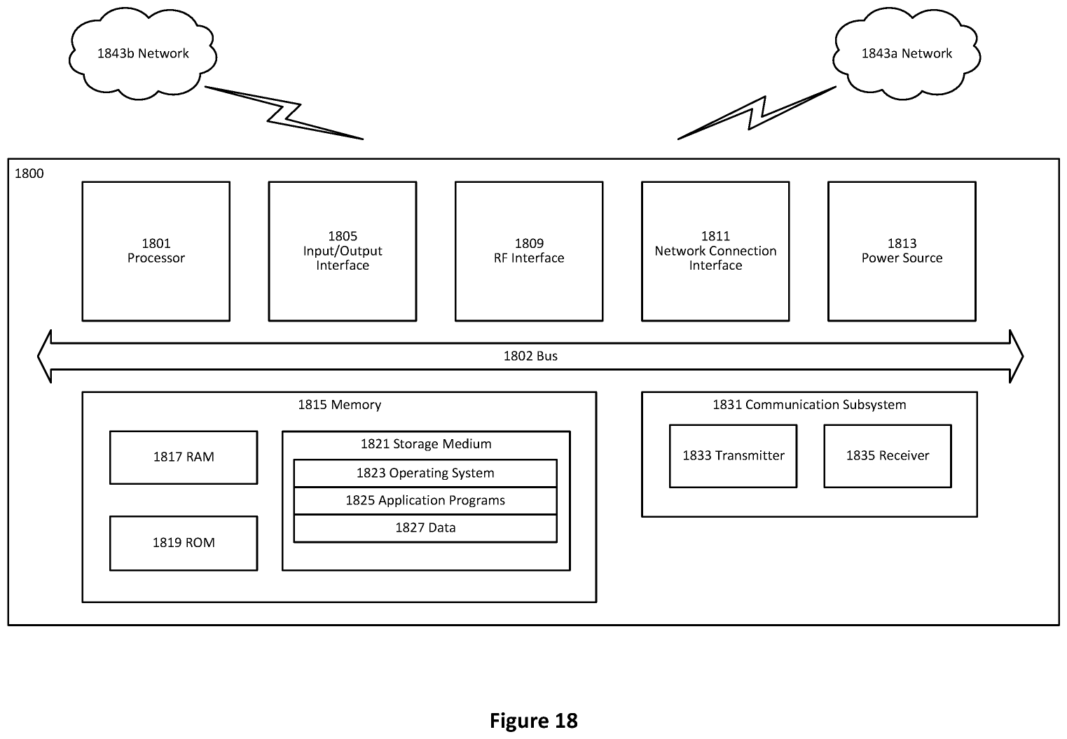

FIG. 18 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 18200 may be any UE identified by the 3^{rd} Generation Partnership Project (3GPP), including a NB-IoT UE, a machine type communication (MTC) UE, and/or an enhanced MTC (eMTC) UE. UE 1800, as illustrated in FIG. 18, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 18 is a UE, the components discussed herein are equally applicable to a WD, and vice-versa.

In FIG. 18, UE 1800 includes processing circuitry 1801 that is operatively coupled to input/output interface 1805, radio frequency (RF) interface 1809, network connection interface 1811, memory 1815 including random access memory (RAM) 1817, read-only memory (ROM) 1819, and storage medium 1821 or the like, communication subsystem 1831, power source 1833, and/or any other component, or any combination thereof. Storage medium 1821 includes operating system 1823, application program 1825, and data 1827. In other embodiments, storage medium 1821 may include other similar types of information. Certain UEs may utilize all of the components shown in FIG. 18, or only a subset of the components. The level of integration between the components may vary from one UE to another UE. Further, certain UEs may contain multiple instances of a component, such as multiple processors, memories, transceivers, transmitters, receivers, etc.

In FIG. 18, processing circuitry 1801 may be configured to process computer instructions and data. Processing circuitry 1801 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1801 may include two central processing units (CPUs). Data may be information in a form suitable for use by a computer.

In the depicted embodiment, input/output interface 1805 may be configured to provide a communication interface to an input device, output device, or input and output device. UE 1800 may be configured to use an output device via input/output interface 1805. An output device may use the same type of interface port as an input device. For example, a USB port may be used to provide input to and output from UE 1800. The output device may be a speaker, a sound card, a video card, a display, a monitor, a printer, an actuator, an emitter, a smartcard, another output device, or any combination thereof. UE 1800 may be configured to use an input device via input/output interface 1805 to allow a user to capture information into UE 1800. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 18, RF interface 1809 may be configured to provide a communication interface to RF components such as a transmitter, a receiver, and an antenna. Network connection interface 1811 may be configured to provide a communication interface to network 1843a. Network 1843a may encompass wired and/or wireless networks such as a local-area network (LAN), a wide-area network (WAN), a computer network, a wireless network, a telecommunications network, another like network or any combination thereof. For example, network 1843a may comprise a Wi-Fi network. Network connection interface 1811 may be configured to include a receiver and a transmitter interface used to communicate with one or more other devices over a communication network according to one or more communication protocols, such as Ethernet, TCP/IP, SONET, ATM, or the like. Network connection interface 1811 may implement receiver and transmitter functionality appropriate to the communication network links (e.g., optical, electrical, and the like). The transmitter and receiver functions may share circuit components, software or firmware, or alternatively may be implemented separately.

RAM 1817 may be configured to interface via bus 1802 to processing circuitry 1801 to provide storage or caching of data or computer instructions during the execution of software programs such as the operating system, application programs, and device drivers. ROM 1819 may be configured to provide computer instructions or data to processing circuitry 1801. For example, ROM 1819 may be configured to store invariant low-level system code or data for basic system functions such as basic input and output (I/O), startup, or reception of keystrokes from a keyboard that are stored in a non-volatile memory. Storage medium 1821 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1821 may be configured to include operating system 1823, application program 1825 such as a web browser application, a widget or gadget engine or another application, and data file 1827. Storage medium 1821 may store, for use by UE 1800, any of a variety of various operating systems or combinations of operating systems.

Storage medium 1821 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1821 may allow UE 1800 to access computer-executable instructions, application programs or the like, stored on transitory or non-transitory memory media, to off-load data, or to upload data. An article of manufacture, such as one utilizing a communication system may be tangibly embodied in storage medium 1821, which may comprise a device readable medium.

In FIG. 18, processing circuitry 1801 may be configured to communicate with network 1843b using communication subsystem 1831. Network 1843a and network 1843b may be the same network or networks or different network or networks. Communication subsystem 1831 may be configured to include one or more transceivers used to communicate with network 1843b. For example, communication subsystem 1831 may be configured to include one or more transceivers used to communicate with one or more remote transceivers of another device capable of wireless communication such as another WD, UE, or base station of a radio access network (RAN) according to one or more communication protocols, such as IEEE 802.18, CDMA, WCDMA, GSM, LTE, UTRAN, WiMax, or the like. Each transceiver may include transmitter 1833 and/or receiver 1835 to implement transmitter or receiver functionality, respectively, appropriate to the RAN links (e.g., frequency allocations and the like). Further, transmitter 1833 and receiver 1835 of each transceiver may share circuit components, software or firmware, or alternatively may be implemented separately.

In the illustrated embodiment, the communication functions of communication subsystem 1831 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1831 may include cellular communication, Wi-Fi communication, Bluetooth communication, and GPS communication. Network 1843b may encompass wired and/or wireless networks such as a local-area network (LAN), a wide-area network (WAN), a computer network, a wireless network, a telecommunications network, another like network or any combination thereof. For example, network 1843b may be a cellular network, a Wi-Fi network, and/or a near-field network. Power source 1813 may be configured to provide alternating current (AC) or direct current (DC) power to components of UE 1800.

The features, benefits and/or functions described herein may be implemented in one of the components of UE 1800 or partitioned across multiple components of UE 1800. Further, the features, benefits, and/or functions described herein may be implemented in any combination of hardware, software or firmware. In one example, communication subsystem 1831 may be configured to include any of the components described herein. Further, processing circuitry 1801 may be configured to communicate with any of such components over bus 1802. In another example, any of such components may be represented by program instructions stored in memory that when executed by processing circuitry 1801 perform the corresponding functions described herein. In another example, the functionality of any of such components may be partitioned between processing circuitry 1801 and communication subsystem 1831. In another example, the non-computationally intensive functions of any of such components may be implemented in software or firmware and the computationally intensive functions may be implemented in hardware.

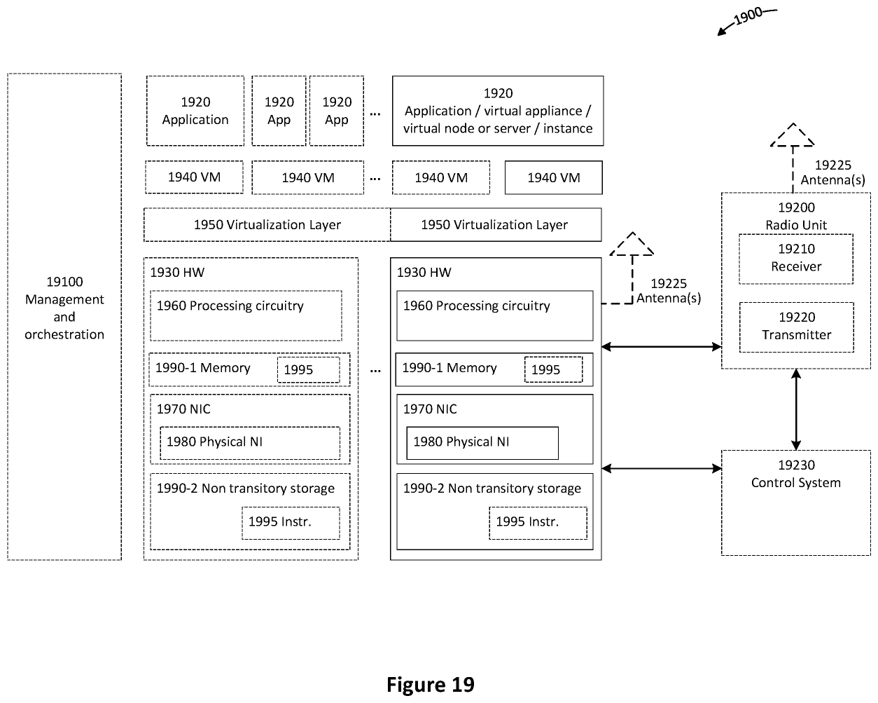

FIG. 19 is a schematic block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1900 hosted by one or more of hardware nodes 1930. Further, in embodiments in which the virtual node is not a radio access node or does not require radio connectivity (e.g., a core network node), then the network node may be entirely virtualized.

The functions may be implemented by one or more applications 1920 (which may alternatively be called software instances, virtual appliances, network functions, virtual nodes, virtual network functions, etc.) operative to implement some of the features, functions, and/or benefits of some of the embodiments disclosed herein. Applications 1920 are run in virtualization environment 1900 which provides hardware 1930 comprising processing circuitry 1960 and memory 1990. Memory 1990 contains instructions 1995 executable by processing circuitry 1960 whereby application 1920 is operative to provide one or more of the features, benefits, and/or functions disclosed herein.

Virtualization environment 1900, comprises general-purpose or special-purpose network hardware devices 1930 comprising a set of one or more processors or processing circuitry 1960, which may be commercial off-the-shelf (COTS) processors, dedicated Application Specific Integrated Circuits (ASICs), or any other type of processing circuitry including digital or analog hardware components or special purpose processors. Each hardware device may comprise memory 1990-1 which may be non-persistent memory for temporarily storing instructions 1995 or software executed by processing circuitry 1960. Each hardware device may comprise one or more network interface controllers (NICs) 1970, also known as network interface cards, which include physical network interface 1980. Each hardware device may also include non-transitory, persistent, machine-readable storage media 1990-2 having stored therein software 1995 and/or instructions executable by processing circuitry 1960. Software 1995 may include any type of software including software for instantiating one or more virtualization layers 1950 (also referred to as hypervisors), software to execute virtual machines 1940 as well as software allowing it to execute functions, features and/or benefits described in relation with some embodiments described herein.

Virtual machines 1940, comprise virtual processing, virtual memory, virtual networking or interface and virtual storage, and may be run by a corresponding virtualization layer 1950 or hypervisor. Different embodiments of the instance of virtual appliance 1920 may be implemented on one or more of virtual machines 1940, and the implementations may be made in different ways.

During operation, processing circuitry 1960 executes software 1995 to instantiate the hypervisor or virtualization layer 1950, which may sometimes be referred to as a virtual machine monitor (VMM). Virtualization layer 1950 may present a virtual operating platform that appears like networking hardware to virtual machine 1940.

As shown in FIG. 19, hardware 1930 may be a standalone network node with generic or specific components. Hardware 1930 may comprise antenna 19225 and may implement some functions via virtualization. Alternatively, hardware 1930 may be part of a larger cluster of hardware (e.g. such as in a data center or customer premise equipment (CPE)) where many hardware nodes work together and are managed via management and orchestration (MANO) 19100, which, among others, oversees lifecycle management of applications 1920.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1940 may be a software implementation of a physical machine that runs programs as if they were executing on a physical, non-virtualized machine. Each of virtual machines 1940, and that part of hardware 1930 that executes that virtual machine, be it hardware dedicated to that virtual machine and/or hardware shared by that virtual machine with others of the virtual machines 1940, forms a separate virtual network elements (VNE).

Still in the context of NFV, Virtual Network Function (VNF) is responsible for handling specific network functions that run in one or more virtual machines 1940 on top of hardware networking infrastructure 1930 and corresponds to application 1920 in FIG. 19.

In some embodiments, one or more radio units 19200 that each include one or more transmitters 19220 and one or more receivers 19210 may be coupled to one or more antennas 19225. Radio units 19200 may communicate directly with hardware nodes 1930 via one or more appropriate network interfaces and may be used in combination with the virtual components to provide a virtual node with radio capabilities, such as a radio access node or a base station.

In some embodiments, some signalling can be affected with the use of control system 19230 which may alternatively be used for communication between the hardware nodes 1930 and radio units 19200.

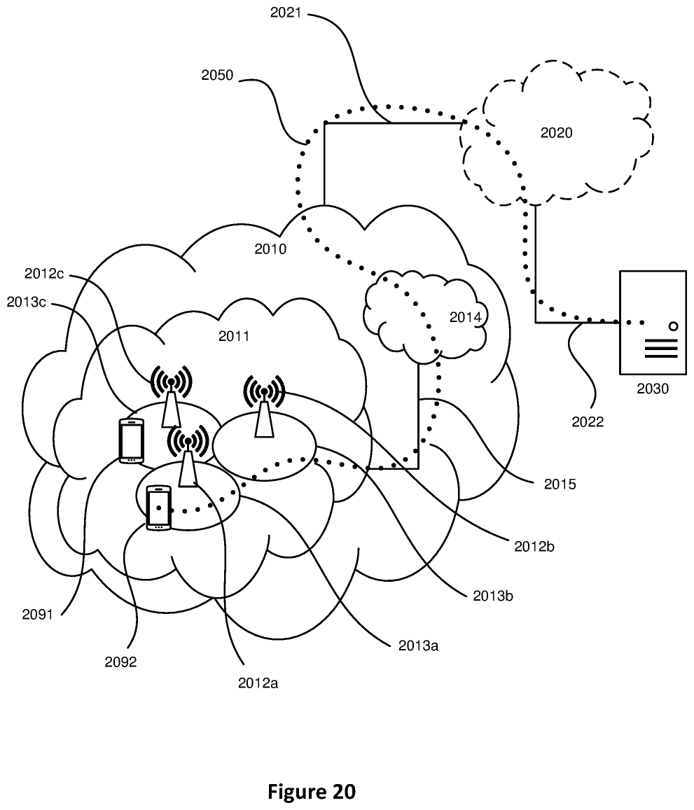

FIG. 20 illustrates a telecommunication network connected via an intermediate network to a host computer in accordance with some embodiments. In particular, with reference to FIG. 20, in accordance with an embodiment, a communication system includes telecommunication network 2010, such as a 3GPP-type cellular network, which comprises access network 2011, such as a radio access network, and core network 2014. Access network 2011 comprises a plurality of base stations 2012a, 2012b, 2012c, such as NBs, eNBs, gNBs or other types of wireless access points, each defining a corresponding coverage area 2013a, 2013b, 2013c. Each base station 2012a, 2012b, 2012c is connectable to core network 2014 over a wired or wireless connection 2015. A first UE 2091 located in coverage area 2013c is configured to wirelessly connect to, or be paged by, the corresponding base station 2012c. A second UE 2092 in coverage area 2013a is wirelessly connectable to the corresponding base station 2012a. While a plurality of UEs 2091, 2092 are illustrated in this example, the disclosed embodiments are equally applicable to a situation where a sole UE is in the coverage area or where a sole UE is connecting to the corresponding base station 2012.

Telecommunication network 2010 is itself connected to host computer 2030, which may be embodied in the hardware and/or software of a standalone server, a cloud-implemented server, a distributed server or as processing resources in a server farm. Host computer 2030 may be under the ownership or control of a service provider, or may be operated by the service provider or on behalf of the service provider. Connections 2021 and 2022 between telecommunication network 2010 and host computer 2030 may extend directly from core network 2014 to host computer 2030 or may go via an optional intermediate network 2020. Intermediate network 2020 may be one of, or a combination of more than one of, a public, private or hosted network; intermediate network 2020, if any, may be a backbone network or the Internet; in particular, intermediate network 2020 may comprise two or more sub-networks (not shown).

The communication system of FIG. 20 as a whole enables connectivity between the connected UEs 2091, 2092 and host computer 2030. The connectivity may be described as an over-the-top (OTT) connection 2050. Host computer 2030 and the connected UEs 2091, 2092 are configured to communicate data and/or signaling via OTT connection 2050, using access network 2011, core network 2014, any intermediate network 2020 and possible further infrastructure (not shown) as intermediaries. OTT connection 2050 may be transparent in the sense that the participating communication devices through which OTT connection 2050 passes are unaware of routing of uplink and downlink communications. For example, base station 2012 may not or need not be informed about the past routing of an incoming downlink communication with data originating from host computer 2030 to be forwarded (e.g., handed over) to a connected UE 2091. Similarly, base station 2012 need not be aware of the future routing of an outgoing uplink communication originating from the UE 2091 towards the host computer 2030.

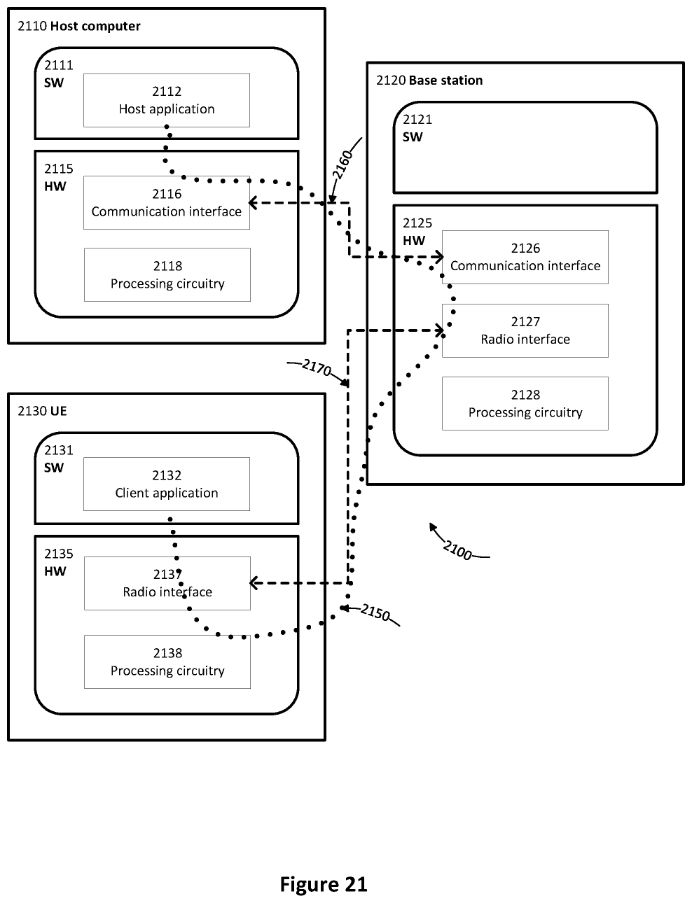

Example implementations, in accordance with an embodiment, of the UE, base station and host computer discussed in the preceding paragraphs will now be described with reference to FIG. 21. FIG. 21 illustrates host computer communicating via a base station with a user equipment over a partially wireless connection in accordance with some embodiments In communication system 2100, host computer 2110 comprises hardware 2115 including communication interface 2116 configured to set up and maintain a wired or wireless connection with an interface of a different communication device of communication system 2100. Host computer 2110 further comprises processing circuitry 2118, which may have storage and/or processing capabilities. In particular, processing circuitry 2118 may comprise one or more programmable processors, application-specific integrated circuits, field programmable gate arrays or combinations of these (not shown) adapted to execute instructions. Host computer 2110 further comprises software 2111, which is stored in or accessible by host computer 2110 and executable by processing circuitry 2118. Software 2111 includes host application 2112. Host application 2112 may be operable to provide a service to a remote user, such as UE 2130 connecting via OTT connection 2150 terminating at UE 2130 and host computer 2110. In providing the service to the remote user, host application 2112 may provide user data which is transmitted using OTT connection 2150.

Communication system 2100 further includes base station 2120 provided in a telecommunication system and comprising hardware 2125 enabling it to communicate with host computer 2110 and with UE 2130. Hardware 2125 may include communication interface 2126 for setting up and maintaining a wired or wireless connection with an interface of a different communication device of communication system 2100, as well as radio interface 2127 for setting up and maintaining at least wireless connection 2170 with UE 2130 located in a coverage area (not shown in FIG. 21) served by base station 2120. Communication interface 2126 may be configured to facilitate connection 2160 to host computer 2110. Connection 2160 may be direct or it may pass through a core network (not shown in FIG. 21) of the telecommunication system and/or through one or more intermediate networks outside the telecommunication system. In the embodiment shown, hardware 2125 of base station 2120 further includes processing circuitry 2128, which may comprise one or more programmable processors, application-specific integrated circuits, field programmable gate arrays or combinations of these (not shown) adapted to execute instructions. Base station 2120 further has software 2121 stored internally or accessible via an external connection.

Communication system 2100 further includes UE 2130 already referred to. Its hardware 2135 may include radio interface 2137 configured to set up and maintain wireless connection 2170 with a base station serving a coverage area in which UE 2130 is currently located. Hardware 2135 of UE 2130 further includes processing circuitry 2138, which may comprise one or more programmable processors, application-specific integrated circuits, field programmable gate arrays or combinations of these (not shown) adapted to execute instructions. UE 2130 further comprises software 2131, which is stored in or accessible by UE 2130 and executable by processing circuitry 2138. Software 2131 includes client application 2132. Client application 2132 may be operable to provide a service to a human or non-human user via UE 2130, with the support of host computer 2110. In host computer 2110, an executing host application 2112 may communicate with the executing client application 2132 via OTT connection 2150 terminating at UE 2130 and host computer 2110. In providing the service to the user, client application 2132 may receive request data from host application 2112 and provide user data in response to the request data. OTT connection 2150 may transfer both the request data and the user data. Client application 2132 may interact with the user to generate the user data that it provides.

It is noted that host computer 2110, base station 2120 and UE 2130 illustrated in FIG. 21 may be similar or identical to host computer 2030, one of base stations 2012a, 2012b, 2012c and one of UEs 2091, 2092 of FIG. 20, respectively. This is to say, the inner workings of these entities may be as shown in FIG. 21 and independently, the surrounding network topology may be that of FIG. 20.

In FIG. 21, OTT connection 2150 has been drawn abstractly to illustrate the communication between host computer 2110 and UE 2130 via base station 2120, without explicit reference to any intermediary devices and the precise routing of messages via these devices. Network infrastructure may determine the routing, which it may be configured to hide from UE 2130 or from the service provider operating host computer 2110, or both. While OTT connection 2150 is active, the network infrastructure may further take decisions by which it dynamically changes the routing (e.g., on the basis of load balancing consideration or reconfiguration of the network).

Wireless connection 2170 between UE 2130 and base station 2120 is in accordance with the teachings of the embodiments described throughout this disclosure. One or more of the various embodiments improve the performance of OTT services provided to UE 2130 using OTT connection 2150, in which wireless connection 2170 forms the last segment.

A measurement procedure may be provided for the purpose of monitoring data rate, latency and other factors on which the one or more embodiments improve. There may further be an optional network functionality for reconfiguring OTT connection 2150 between host computer 2110 and UE 2130, in response to variations in the measurement results. The measurement procedure and/or the network functionality for reconfiguring OTT connection 2150 may be implemented in software 2111 and hardware 2115 of host computer 2110 or in software 2131 and hardware 2135 of UE 2130, or both. In embodiments, sensors (not shown) may be deployed in or in association with communication devices through which OTT connection 2150 passes; the sensors may participate in the measurement procedure by supplying values of the monitored quantities exemplified above, or supplying values of other physical quantities from which software 2111, 2131 may compute or estimate the monitored quantities. The reconfiguring of OTT connection 2150 may include message format, retransmission settings, preferred routing etc.; the reconfiguring need not affect base station 2120, and it may be unknown or imperceptible to base station 2120. Such procedures and functionalities may be known and practiced in the art. In certain embodiments, measurements may involve proprietary UE signaling facilitating host computer 2110's measurements of throughput, propagation times, latency and the like. The measurements may be implemented in that software 2111 and 2131 causes messages to be transmitted, in particular empty or ‘dummy’ messages, using OTT connection 2150 while it monitors propagation times, errors etc.

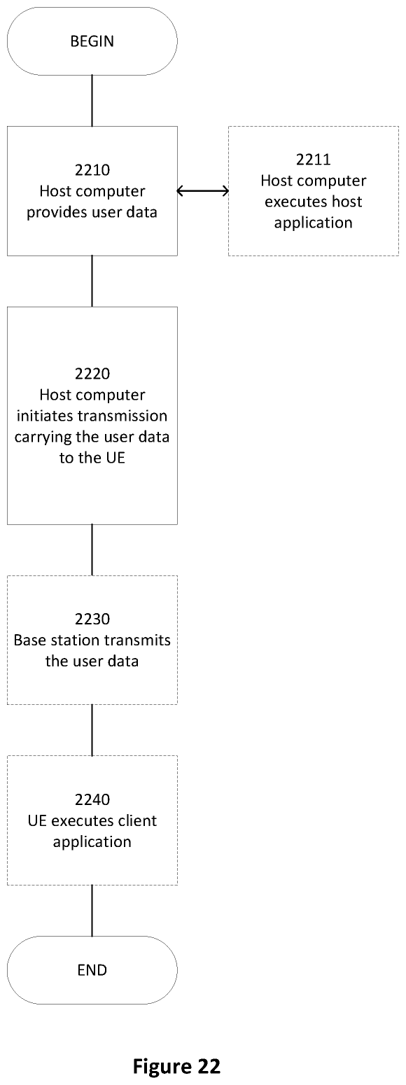

FIG. 22 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 22 will be included in this section. In step 2210, the host computer provides user data. In substep 2211 (which may be optional) of step 2210, the host computer provides the user data by executing a host application. In step 2220, the host computer initiates a transmission carrying the user data to the UE. In step 2230 (which may be optional), the base station transmits to the UE the user data which was carried in the transmission that the host computer initiated, in accordance with the teachings of the embodiments described throughout this disclosure. In step 2240 (which may also be optional), the UE executes a client application associated with the host application executed by the host computer.

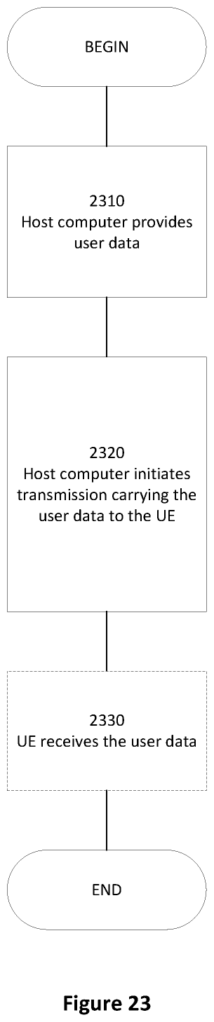

FIG. 23 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 23 will be included in this section. In step 2310 of the method, the host computer provides user data. In an optional substep (not shown) the host computer provides the user data by executing a host application. In step 2320, the host computer initiates a transmission carrying the user data to the UE. The transmission may pass via the base station, in accordance with the teachings of the embodiments described throughout this disclosure. In step 2330 (which may be optional), the UE receives the user data carried in the transmission.

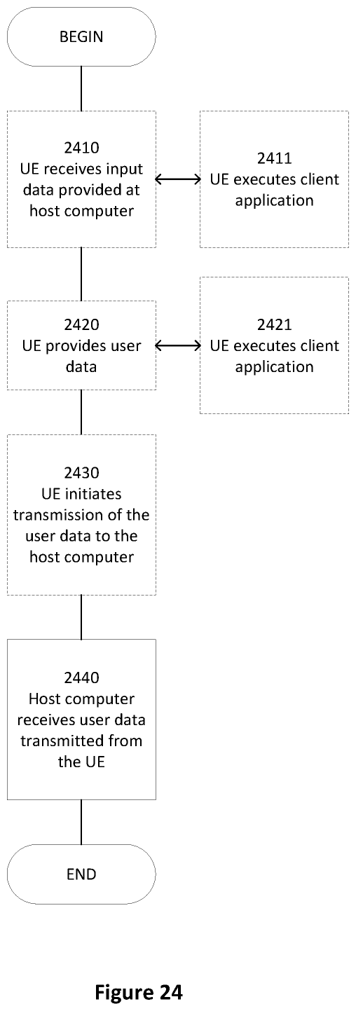

FIG. 24 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 24 will be included in this section. In step 2410 (which may be optional), the UE receives input data provided by the host computer. Additionally or alternatively, in step 2420, the UE provides user data. In substep 2421 (which may be optional) of step 2420, the UE provides the user data by executing a client application. In substep 2411 (which may be optional) of step 2410, the UE executes a client application which provides the user data in reaction to the received input data provided by the host computer. In providing the user data, the executed client application may further consider user input received from the user. Regardless of the specific manner in which the user data was provided, the UE initiates, in substep 2430 (which may be optional), transmission of the user data to the host computer. In step 2440 of the method, the host computer receives the user data transmitted from the UE, in accordance with the teachings of the embodiments described throughout this disclosure.

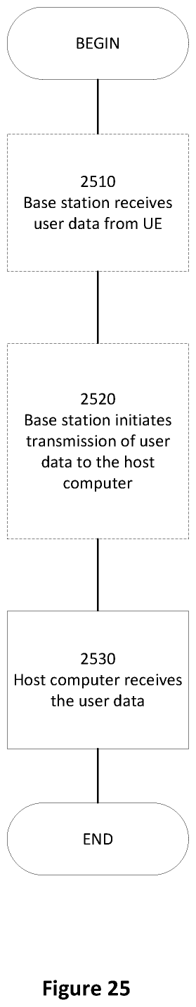

FIG. 25 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 25 will be included in this section. In step 2510 (which may be optional), in accordance with the teachings of the embodiments described throughout this disclosure, the base station receives user data from the UE. In step 2520 (which may be optional), the base station initiates transmission of the received user data to the host computer. In step 2530 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. Additional information may also be found in the document(s) provided in the Appendix.

1-50. (canceled)

51. A wireless device comprising:
communication circuitry; and
processing circuitry configured to:
map a first type of identity usable in a first type of wireless communication network to a second type of identity usable in a second type of wireless communication network, wherein the second type of identity is mappable from any one of multiple different possible types of identities usable in different respective types of networks, wherein the multiple different possible types of identities include the first type of identity; and
transmit to a base station signaling that includes the second type of identity and that indicates a type of identity, from among the multiple different possible types of identities, from which the second type of identity is mapped by indicating that the second type of identity is mapped from the first type of identity.

52. The wireless device of claim 51, wherein the second type of identity is a second type of network node identity usable to identify a network node in the second type of wireless communication network.

53. The wireless device of claim 51, wherein the second type of identity is a globally unique Mobility Management Entity, MME, identity, GUMMEI.

54. The wireless device of claim 53, wherein said signaling comprises a Radio Resource Control, RRC, connection setup complete message, wherein the RRC connection setup complete message includes a GUMMEI type field, wherein a first possible value of the GUMMEI type field indicates that the second type of identity is mapped from a 5G identifier, wherein a second possible value of the GUMMEI type field indicates that the second type of identity is mapped from a 2G or 3G identifier, and wherein the GUMMEI type field included in the RRC connection setup complete message transmitted by the wireless device has the first possible value to indicate the second type of identity is mapped from a 5G identifier.

55. The wireless device of claim 51, wherein the first type of identity is a 5G identity and the first type of wireless communication network is a 5G wireless communication network, and wherein the different respective types of wireless communication networks include:
a 5G wireless communication network; and
a 2G wireless communication network and/or a 3G wireless communication network.

56. The wireless device of claim 51, wherein the first type of identity is either a globally unique Access and Mobility Function, AMF, identity, GUAMI, or a 5G globally unique temporary identity, 5G-GUTI.

57. The wireless device of claim 51, wherein the processing circuitry is configured to perform a procedure associated with mobility of the wireless device from the first type of wireless communication network to the second type of wireless communication network, and wherein said signaling is transmitted from the wireless device as part of the procedure.

58. A base station comprising:
communication circuitry; and
processing circuitry configured to:
receive signaling from a wireless device;
wherein the signaling includes a second type of identity usable in a second type of wireless communication network, wherein the second type of identity is mappable from any one of multiple different possible types of identities usable in different respective types of networks, wherein the multiple different possible types of identities include a first type of identity usable in a first type of wireless communication network; and
wherein the signaling indicates a type of identity, from among the multiple different possible types of identities, from which the second type of identity is mapped by indicating that the second type of identity is mapped from the first type of identity.

59. The base station of claim 58, wherein the processing circuitry is further configured to:
select a network node to which to route the signaling, based on the second type of identity and indication that the second type of identity is mapped from the first type of identity; and
route the signaling according to said selecting.

60. The base station of claim 58, wherein the processing circuitry is configured to perform a procedure associated with mobility of the wireless device from the first type of wireless communication network to the second type of wireless communication network, wherein said signaling is received from the wireless device as part of the procedure.

61. The base station of claim 58, wherein the second type of identity is a second type of network node identity usable to identify a network node in the second type of wireless communication network.

62. The base station of claim 58, wherein the second type of identity is a globally unique Mobility Management Entity, MME, identity, GUMMEI.

63. The base station of claim 62, wherein said signaling comprises a Radio Resource Control, RRC, connection setup complete message, wherein the RRC connection setup complete message includes a GUMMEI type field, wherein a first possible value of the GUMMEI type field indicates that the second type of identity is mapped from a 5G identifier, wherein a second possible value of the GUMMEI type field indicates that the second type of identity is mapped from a 2G or 3G identifier, and wherein the GUMMEI type field included in the RRC connection setup complete message transmitted by the wireless device has the first possible value to indicate the second type of identity is mapped from a 5G identifier.

64. The base station of claim 58, wherein the first type of identity is a 5G identity and the first type of wireless communication network is a 5G network, and wherein the different respective types of networks include: a 5G network; and a 2G network and/or a 3G network.

65. The base station of claim 58, wherein the first type of identity is either a globally unique Access and Mobility Function, AMF, identity, GUAMI, or a 5G globally unique temporary identity, 5G-GUTI.

66. A base station comprising:
communication circuitry; and
processing circuitry configured to receive signaling indicating which identities of a second type usable in a second type of wireless communication network are mapped from respective identities of a first type usable in a first type of wireless communication network, wherein the second type of identity is mappable from any one of multiple different possible types of identities usable in different respective types of networks, wherein the multiple different possible types of identities include the first type of identity.

67. The base station of claim 66, wherein the second type of identity is a globally unique Mobility Management Entity, MME, identity, GUMMEI, the first type of identity is a 5G identity, and the first type of wireless communication network is a 5G network.

68. A method performed by a wireless device, the method comprising:
mapping a first type of identity usable in a first type of wireless communication network to a second type of identity usable in a second type of wireless communication network, wherein the second type of identity is mappable from any one of multiple different possible types of identities usable in different respective types of wireless communication networks, wherein the multiple different possible types of identities include the first type of identity; and
transmitting to a base station signaling that includes the second type of identity and that indicates a type of identity, from among the multiple different possible types of identities, from which the second type of identity is mapped by indicating that the second type of identity is mapped from the first type of identity.

69. The method of claim 68, wherein the second type of identity is a globally unique Mobility Management Entity, MME, identity, GUMMEI, wherein said signaling comprises a Radio Resource Control, RRC, connection setup complete message, wherein the RRC connection setup complete message includes a GUMMEI type field, wherein a first possible value of the GUMMEI type field indicates that the second type of identity is mapped from a 5G identifier, wherein a second possible value of the GUMMEI type field indicates that the second type of identity is mapped from a 2G or 3G identifier, and wherein the GUMMEI type field included in the RRC connection setup complete message transmitted by the wireless device has the first possible value to indicate the second type of identity is mapped from a 5G identifier.

70. The method of claim 68, wherein the first type of identity is a 5G identity and the first type of wireless communication network is a 5G wireless communication network, and wherein the different respective types of wireless communication networks include:
a 5G wireless communication network; and
a 2G wireless communication network and/or a 3G wireless communication network.

71. The method of claim 68, wherein the first type of identity is either a globally unique Access and Mobility Function, AMF, identity, GUAMI, or a 5G globally unique temporary identity, 5G-GUTI.

72. A method performed by a base station, the method comprising:
receiving signaling from a wireless device;
wherein the signaling includes a second type of identity usable in a second type of wireless communication network, wherein the second type of identity is mappable from any one of multiple different possible types of identities usable in different respective types of networks, wherein the multiple different possible types of identities include a first type of identity usable in a first type of wireless communication network; and
wherein the signaling indicates a type of identity, from among the multiple different possible types of identities, from which the second type of identity is mapped by indicating that the second type of identity is mapped from the first type of identity.

73. The method of claim 72, further comprising:
selecting a network node to which to route the signaling, based on the second type of identity and indication that the second type of identity is mapped from the first type of identity; and
routing the signaling according to said selecting.

74. The method of claim 72, wherein the second type of identity is a globally unique Mobility Management Entity, MME, identity, GUMMEI, wherein said signaling comprises a Radio Resource Control, RRC, connection setup complete message, wherein the RRC connection setup complete message includes a GUMMEI type field, wherein a first possible value of the GUMMEI type field indicates that the second type of identity is mapped from a 5G identifier, wherein a second possible value of the GUMMEI type field indicates that the second type of identity is mapped from a 2G or 3G identifier, and wherein the GUMMEI type field included in the RRC connection setup complete message transmitted by the wireless device has the first possible value to indicate the second type of identity is mapped from a 5G identifier.

75. A method performed by a base station, the method comprising:
receiving signaling indicating which identities of a second type usable in a second type of wireless communication network are mapped from respective identities of a first type usable in a first type of wireless communication network, wherein the second type of identity is mappable from any one of multiple different possible types of identities usable in different respective types of networks, wherein the multiple different possible types of identities include the first type of identity.

76. The method of claim 75, wherein the second type of identity is a globally unique Mobility Management Entity, MME, identity, GUMMEI, the first type of identity is a 5G identity, and the first type of wireless communication network is a 5G network.
